(19) United States
(12) Patent Application Publication
(10) Pub. No.: US 2026/0030977 A1
(43) Pub. Date: Jan. 29, 2026

(54) SYSTEMS AND METHODS FOR LANE IDENTIFICATION USING COLLECTIVE PATTERNS OF CONNECTED VEHICLES

(71) Applicant: TOYOTA MOTOR ENGINEERING & MANUFACTURING NORTH AMERICA, INC., PLANO, TX (US)

(72) Inventors: YASHAR ZEIYNALI FARID, Mountain View, CA (US); EMRAH AKIN SISBOT, Mountain View, CA (US); DIVYA SAI TOOPRAN, Mountain View, CA (US); KENTARO OGUCHI, Mountain View, CA (US)

(73) Assignees: TOYOTA MOTOR ENGINEERING & MANUFACTURING NORTH AMERICA, INC., PLANO, TX (US); TOYOTA JIDOSHA KABUSHIKI KAISHA, TOYOTA-SHI (JP)

(21) Appl. No.: 18/781,113

(22) Filed: Jul. 23, 2024

(51) Int. Cl. G08G 1/01; G08G 1/00

(52) U.S. Cl. CPC G08G 1/0141; G08G 1/0112; G08G 1/20

(57) ABSTRACT

Systems and methods are provided for lane identification for a first vehicle on a road segment. The systems and methods may identify a plurality of lane-level patterns for a plurality of other vehicles that traveled on the road segment. The systems and methods may assign each vehicle of the plurality of other vehicles to one of the lane-level patterns to sort the vehicles of the plurality of other vehicles into one or more clusters of vehicles. The systems and methods may determine a lane identification for each cluster of vehicles. The systems and methods may generate a lane identification distribution for the first vehicle based on sensor data of the first vehicle and the lane identification for each cluster of vehicles. The systems and methods may estimate a lane identification for the first vehicle based on the lane identification distribution.

### TECHNICAL FIELD

The present disclosure relates generally to vehicles, and more particularly some aspects of the systems and methods disclosed herein relate to lane identification on a road for vehicles.

### BACKGROUND OF THE INVENTION

Roadways serve numerous essential purposes that underpin the functioning of modern society. Roads are regularly used to facilitate the transportation of people and goods through vehicles, which may include automobiles, trucks, motorcycles, bicycles, scooters, mopeds, recreational vehicles and other like on- or off-road vehicles. Vehicles may further include autonomous, semi-autonomous and manual vehicles.

With numerous vehicles traveling on roads at any given time, it may be important for vehicles to properly identify a lane on a road on which they are traveling. Some, but not all, conventional vehicles include one or more sensors that may be used to collect data regarding lane markings and other objects on the roadway, and to monitor the condition and features of roads. Conventional solutions utilize a single vehicle's data to estimate lane identification of that specific vehicle. Often such systems require sensors that are unavailable in many vehicles or that are unable to collect sufficient data. In addition, lane identification estimates obtained from such models can be highly uncertain.

While mapping and monitoring systems may be used to monitor and evaluate roads, current programs have difficulty accurately identifying lanes of a road according to road conditions and features. Properly identifying lanes on a road that vehicles are traveling on may prevent incidents and accidents occurring on the road, and may allow ground services or resources to be properly navigated on a road to avoid any road conditions and features that may otherwise cause delays or damage, which can be costly.

### BRIEF SUMMARY OF THE DISCLOSURE

According to various aspects of the disclosed technology, systems and methods for lane identification of a road are provided. In accordance with some implementations, a method for lane identification for a first vehicle on a road segment is provided. The method may include: identifying, based on sensor data from a plurality of other vehicles that traveled on the road segment, a plurality of lane-level patterns for the plurality of other vehicles; assigning each vehicle of the plurality of other vehicles to one of the lane-level patterns to sort the vehicles of the plurality of other vehicles into one or more clusters of vehicles; determining a lane identification for each cluster of vehicles; generating a lane identification distribution for the first vehicle based on sensor data of the first vehicle and the lane identification for each cluster of vehicles; and estimating a lane identification for the first vehicle based on the generated lane identification distribution.

In some applications, the sensor data of a vehicle is obtained from a sensor of the vehicle and the sensor may include at least one of a camera, image sensor, radar sensor, light detection and ranging (LIDAR) sensor, position sensor, audio sensor, infrared sensor, microwave sensor, optical sensor, haptic sensor, magnetometer, communication system and global positioning system (GPS).

In some applications, the sensor data of a vehicle may include information of an environmental condition, road condition, map, location, lane marker type, traffic, speed, direction, and object encountered by the vehicle.

In some applications, the object may include at least one of a pothole, crack, tire marking, faded road marking, debris, occlusion, road reflection, flooding, ice, fire, oil leak, uneven pavement, erosion, raveling, sign, pole, building, structure, pedestrian, animal, and vehicle.

In some applications, the lane-level pattern of a vehicle comprises at least one of an acceleration profile pattern, suspension pattern, speed pattern, detected object pattern, road condition pattern, traffic pattern, direction pattern, and driving pattern.

In some applications, the plurality of other vehicles are sorted into clusters of vehicles so that each vehicle in a cluster has a similar lane-level pattern to other vehicles in the cluster.

In some applications, the method may further include updating the lane identification distribution as the first vehicle traverses the road segment according to the sensor data of the first vehicle and the lane identifications for the one or more clusters of vehicles.

In some applications, the method may further include outputting the lane identification distribution and the estimated lane identification of the first vehicle.

In another aspect, a system for lane identification for a first vehicle on a road segment is provided that may include one or more processors; and memory coupled to the one or more processors to store instructions, which when executed by the one or more processors, may cause the one or more processors to perform operations. The operations may include: identifying, based on sensor data from a plurality of other vehicles that traveled on the road segment, a plurality of lane-level patterns for the plurality of other vehicles; assigning each vehicle of the plurality of other vehicles to one of the lane-level patterns to sort the vehicles of the plurality of other vehicles into one or more clusters of vehicles; determining a lane identification for each cluster of vehicles; generating a lane identification distribution for the first vehicle based on sensor data of the first vehicle and the lane identification for each cluster of vehicles; and estimating a lane identification for the first vehicle based on the generated lane identification distribution.

In some applications, the sensor data of a vehicle is obtained from a sensor of the vehicle and the sensor may include at least one of a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

In some applications, the sensor data of a vehicle may include information of an environmental condition, road condition, map, location, lane marker type, traffic, speed, direction, and object encountered by the vehicle.

In some applications, the object may include at least one of a pothole, crack, tire marking, faded road marking, debris, occlusion, road reflection, flooding, ice, fire, oil leak, uneven pavement, erosion, raveling, sign, pole, building, structure, pedestrian, animal, and vehicle.

In some applications, the lane-level pattern of a vehicle comprises at least one of an acceleration profile pattern, suspension pattern, speed pattern, detected object pattern, road condition pattern, traffic pattern, direction pattern, and driving pattern.

In some applications, the plurality of other vehicles are sorted into clusters of vehicles so that each vehicle in a cluster has a similar lane-level pattern to other vehicles in the cluster.

In some applications, the system may further include operations comprising updating the lane identification distribution as the first vehicle traverses the road segment according to the sensor data of the first vehicle and the lane identifications for the one or more clusters of vehicles.

In some applications, the system may further include operations comprising outputting the lane identification distribution and the estimated lane identification of the first vehicle.

In another aspect, a non-transitory machine-readable medium is provided. The non-transitory computer-readable medium may include instructions that when executed by a processor may cause the processor to perform operations including: identifying, based on sensor data from a plurality of other vehicles that traveled on a road segment, a plurality of lane-level patterns for the plurality of other vehicles; assigning each vehicle of the plurality of other vehicles to one of the lane-level patterns to sort the vehicles of the plurality of other vehicles into one or more clusters of vehicles; determining a lane identification for each cluster of vehicles; generating a lane identification distribution for a first vehicle on the road segment based on sensor data of the first vehicle and the lane identification for each cluster of vehicles; and estimating a lane identification for the first vehicle based on the generated lane identification distribution.

In some applications, the sensor data of a vehicle is obtained from a sensor of the vehicle and the sensor may include at least one of a camera, image sensor, radar sensor, light detection and ranging (LIDAR) sensor, position sensor, audio sensor, infrared sensor, microwave sensor, optical sensor, haptic sensor, magnetometer, communication system and global positioning system (GPS).

In some applications, the sensor data of a vehicle may include information of an environmental condition, road condition, map, location, lane marker type, traffic, speed, direction, and object encountered by the vehicle.

In some applications, the object may include at least one of a pothole, crack, tire marking, faded road marking, debris, occlusion, road reflection, flooding, ice, fire, oil leak, uneven pavement, erosion, raveling, sign, pole, building, structure, pedestrian, animal, and vehicle.

In some applications, the lane-level pattern of a vehicle comprises at least one of an acceleration profile pattern, suspension pattern, speed pattern, detected object pattern, road condition pattern, traffic pattern, direction pattern, and driving pattern.

In some applications, the plurality of other vehicles are sorted into clusters of vehicles so that each vehicle in a cluster has a similar lane-level pattern to other vehicles in the cluster.

In some applications, the non-transitory machine-readable medium may further include operations comprising updating the lane identification distribution as the first vehicle traverses the road segment according to the sensor data of the first vehicle and the lane identifications for the one or more clusters of vehicles.

In some applications, the non-transitory machine-readable medium may further include operations comprising outputting the lane identification distribution and the estimated lane identification of the first vehicle.

Other features and aspects of the disclosed technology will become apparent from the following detailed description, taken in conjunction with the accompanying drawings, which illustrate, by way of example, the features in accordance with applications of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various applications, is described in detail with reference to the following figures. The figures are provided for purposes of illustration only and merely depict typical or example applications.

FIG. 1 illustrates an example computing system for lane identification, according to example applications described in the present disclosure.

FIG. 2 illustrates an example vehicle with which applications of the disclosed technology may be implemented.

FIG. 3 illustrates an example system for lane identification, according to example applications described in the present disclosure.

FIG. 4 illustrates an example process for lane identification, according to example applications described in the present disclosure.

FIG. 5 illustrates an example system for lane identification, according to example applications described in the present disclosure.

FIG. 6 illustrates an example system for lane identification, according to example applications described in the present disclosure.

FIG. 7 illustrates an example computing component that includes one or more hardware processors and machine-readable storage media storing a set of machine-readable/machine-executable instructions that, when executed, cause the one or more hardware processors to perform an illustrative method for lane identification, according to example embodiments described in the present disclosure.

FIG. 8 is an illustration of an example computing component that may be used to implement various features of embodiments described in the present disclosure.

The figures are not exhaustive and do not limit the present disclosure to the precise form disclosed.

### DETAILED DESCRIPTION

As described above, roads may be used as a means of facilitating vehicular transportation for personal, commercial, industrial, governmental, and other purposes. Vehicles may include automobiles, trucks, motorcycles, bicycles, scooters, mopeds, recreational vehicles and other like on- or off-road vehicles. Vehicles may further include autonomous, semi-autonomous and manual vehicles. Roads may include public and private infrastructure elements on which vehicles may travel, such as streets, arteries, highways, alleyways, easements, parking lots, and other.

Aspects of the technology disclosed herein may provide systems and methods configured to determine and identify lanes of a road. More particularly, some aspects of the technology may provide systems and methods for lane identification of connected vehicles on a given road segment utilizing other connected vehicles' data. This may include, for example, utilizing collective patterns of connected vehicles to identify the traveled lane of each vehicle. This may be particularly useful in various situations, including in a situation in which lane identification (ID) of some vehicles can be determined, but for the rest of the vehicles, existing methods cannot correctly estimate the lane IDs. In such circumstances, the disclosed systems and methods may observe collective patterns and cluster vehicles with similar pattens. For example, if the lane identification(s) of one or more vehicles within a cluster of vehicles is/are known, then that known lane identification can be used to estimate the lane identification of the other vehicles within that cluster or of other vehicles with the same pattern. This may present an improvement over conventional technology that utilizes a single vehicle's data to estimate the lane of that vehicle. With such conventional systems, sensor data for lane estimation may be inadequate or unavailable for lane estimation and lane estimate results can be highly uncertain.

An ego vehicle may be traveling on a road. The ego vehicle may include one or more sensors that may be used to collect sensor data and map data of the road that upon which the vehicle is traveling. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received from at least one sensor of the ego vehicle. The sensor data may include information on the condition of the road, damage to the road, hazardous features on the road, attributes of the road (i.e., the color, size, type and shape of lane markers, the number of lanes, lane width, etc.), environmental conditions, lane markers and markings within the lane, map, location, traffic, speed, direction, and objects on, proximate to, and associated with the road that is collected by the ego vehicle. An object on the road may include a pothole, crack, tire marking, faded road marking, debris, occlusion, road reflection, flooding, ice, fire, oil leak, uneven pavement, erosion, raveling, sign, pole, building, structure, pedestrian, animal, and vehicle. The environmental conditions may include location, coordinates, population, landscape, landmark, terrain, territory, weather, temperature, humidity, pollution, habitat, and other environmental surroundings on, proximate to, or associated with the road upon which the ego vehicle is traveling.

The ego vehicle may collect map data of the road that the ego vehicle is traveling on. The map data, which may be stored onboard the vehicle or obtained from the cloud or other infrastructure element, may include location, coordinates, population, landscape, landmark, terrain, territory, weather, temperature, humidity, pollution, habitat, and other environmental surroundings on, proximate to, and associated with the road that the ego vehicle is traveling on. The map data, sensor data or both may be analyzed to determine a position of the ego vehicle on the road.

One or more vehicles that traversed or that are traversing a determined segment of the road on which the ego vehicle is traveling may be identified. The identification can be based on factors such as the timeframe that the other vehicles traversed the road segment. For example, the identification may be limited to vehicles that traveled on the same road segment within a given amount of time prior to the current time at which the ego vehicle is traveling on the road segment. This time window may be set as a predetermined amount of time and the predetermined amount of time may vary based on the circumstances or conditions.

The identification of vehicles may also be based on a distance threshold to a position of interest of the ego vehicle. This may be determined, for example, based on the road segment (e.g., any vehicle within the identified road segment, or vehicles within the road segment that are also within a determined distance of a position of the ego vehicle), including one or more vehicles within a distance threshold to the position of the ego vehicle. The distance threshold may be a preset value. The distance threshold may vary according to the location of the ego vehicle as determined from the map data. The distance threshold may vary according to conditions and features of the road as determined from the sensor data. The distance threshold may be updated according to algorithms and models using data of vehicles. Many variations are possible.

The identified vehicles, hereinafter referred to as subset of vehicles, may also include one or more vehicles enroute in the same direction on the road as the ego vehicle and that was previously at or proximate to the location of the ego vehicle within a time threshold. A vehicle may be determined to be enroute in the same direction on the road as the ego vehicle according to the vehicle's location and direction of movement. A vehicle may be determined to be enroute in the same direction on the road as the ego vehicle according to a GPS of the vehicle.

The GPS of the vehicle may include instructions and directions of a route that the vehicle may follow to reach a particular destination. The instructions and directions of the route of the GPS may include the location of the vehicle. The location of the vehicle may be used to determine an amount of time that has passed since the vehicle was at or proximate to the present location of the ego vehicle. The time threshold may be a preset value. The time threshold may vary according to the location of the ego vehicle as determined from the map data. The time threshold may vary according to conditions and features of the road as determined from the sensor data. The time threshold may be updated according to algorithms and models using data of vehicles. Many variations are possible.

The subset of vehicles may further include one or more vehicles that have one or more sensors capable of collecting data of the road and the driving performance of the respective vehicle. One or more sensors, either individually or in combination, may be able to collect data on the road, such as sensor data, to determine conditions and features of the road. The one or more sensors, either individually or in combination, may be able to collect data on the driving performance of the respective vehicle to determine the driving pattern of the respective vehicle on the road. The one or more sensors of the vehicle used to collect data may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

The subset of vehicles may further include one or more vehicles based on performance data of the respective vehicle with regards to how accurately the respective vehicle follows navigation directions, avoids obstructions, and performs defensive driving. The subset of vehicles may further include one or more vehicles that are associated with a lane identification system, such as, for example, vehicles owned by municipality, autonomous ego motions, city patrollers and the like.

Each of the identified subset of vehicles may communicate to one another using a P2P (peer-to-peer), V2V or other communication protocol. The identified subset of vehicles may move as a convoy or a platoon, according to a navigation strategy, to collect data of the road and data of the subset of vehicles.

Each of the subset of vehicles may have its own sensor data. The sensor data of each of the subset of vehicles may include a direction, speed, driving pattern, location, road condition, map, location, traffic, object, and environmental condition that the respective one of the subset of vehicles encountered during its travel on the road.

The sensor data of the subset of vehicles may be analyzed to determine lane-level patterns of the road. The lane-level patterns may include information of a pattern that is performed and/or experienced by vehicles on the road, such as, for example, a driving pattern, acceleration profile pattern, suspension pattern, speed pattern, detected object pattern, road condition pattern, traffic pattern, and direction pattern pertaining to each of the subset of vehicles as they each travel on the road. The lane-level patterns of vehicles on the road may be used to sort each of the subset of vehicles into clusters of vehicles so that each vehicle in a cluster may have a similar, if not the same, lane-level pattern to other vehicles in the same cluster.

The sensor data of the vehicles on the road, including the ego vehicle and the subset of vehicles, and the lane-level patterns may be analyzed to determine information associated with the lanes of the road. Such information associated with the lanes of the road may be considered as lane identification information. The lane identification information of the road may include a lane marker types (i.e., dashed, solid, white, yellow, double, etc.), flow of traffic, driving pattern, obstruction, object, and road condition of each lane on the road. In this way, the lane identification information may be analyzed to identify each lane on the road.

The lane identification information of the road and the position of the ego vehicle on the road may be analyzed to generate a lane identification distribution indicative of the probabilities that the ego vehicle is in each of the number of lanes on the road. The lane identification probability of each lane on the road may be a value between 0 and 1. The total value of the lane identification probabilities of all of the lanes on the road may equal 1. The lane on the road with the highest value of lane identification probability may be indicative of the lane on the road that the ego vehicle is most likely located in while traveling on the road. The lane identification distribution may include each lane identification probability of each lane of the number of lanes on the road.

The lane identification distribution with each lane identification probability of each lane on the road may be updated as the ego vehicle travels on the road. As the ego vehicle travels on the road, the ego vehicle may collect new sensor data and new map data that may update the position of the ego vehicle and information of the road at the updated position of the ego vehicle. New lane identification information may also be determined from data of the subset of vehicles at the updated position of the ego vehicle on the road. The new sensor data, new map data, and new lane identification information may all be analyzed to update the lane identification probability of each lane on the road at the updated position of the ego vehicle on the road. The updated lane identification distribution may be indicative of a new set of probabilities that the ego vehicle is in each of the number of lanes on the road. The lane identification distribution may further be updated according to algorithms and models using data received from various vehicles that may not be included in the subset of vehicles.

Analyzing the lane identification distribution of each lane identification probability of each lane on the road according to the current position of the ego vehicle on the road, a lane identification may be determined for the ego vehicle. The lane identification may be indicative of the lane on the road that the ego vehicle is currently traveling on. The lane identification probability for each lane on the road, along with the lane identification for the ego vehicle, may be outputted to the ego vehicle, a vehicle monitoring system, a vehicle navigation system, etc.

Monitoring data of various vehicles traveling on a road may permit up-to-date lane identification information and road conditions, that may be analyzed to efficiently and accurately determine lane identifications of the road. The efficient and accurate determination of line identifications of the road may improve the navigation of vehicles traveling on the road and increase the avoidance of incidents and accidents occurring on the road.

It should be noted that the terms “accurate,” “accurately,” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

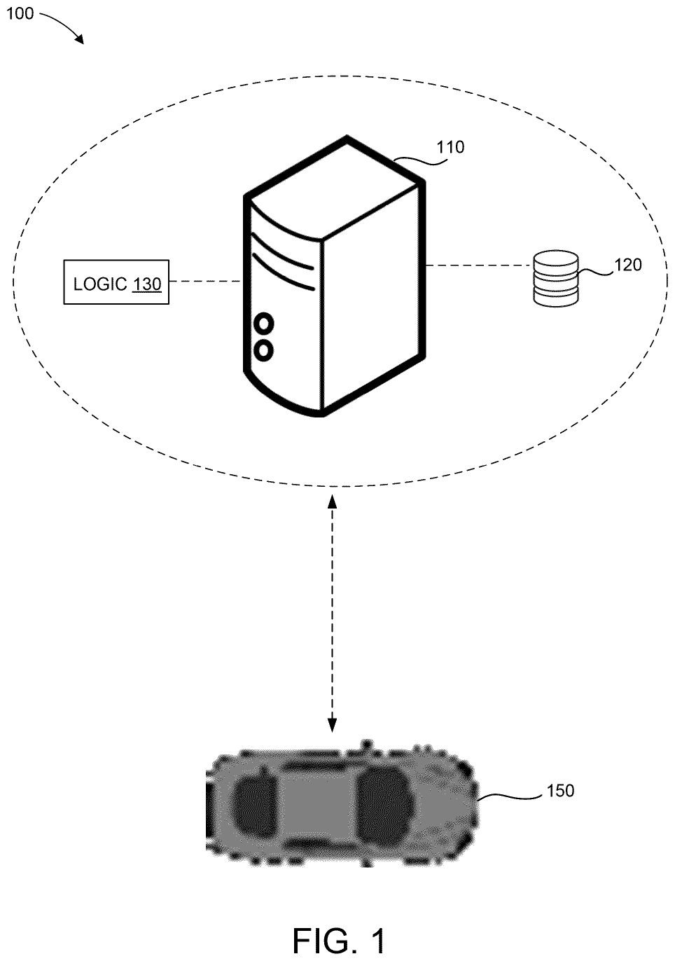

FIG. 1 illustrates an example of a computing system 100 which may be internal or otherwise associated within a vehicle 150. In some embodiments, the computing system 100 may be a machine learning (ML) pipeline and model, and use ML algorithms. In some examples, vehicle 150 may include an autonomous, semi-autonomous or manual vehicle, with which applications of the disclosed technology may be implemented. In some examples, vehicle 150 may include an automobile, truck, motorcycle, bicycle, scooter, moped, recreational vehicle and other like on- or off-road vehicles, that may include an autonomous, semi-autonomous and manual operation. In some examples, the vehicle 150 may include a computing device, such as a desktop computer, a laptop, a mobile phone, a tablet device, an Internet of Things (IoT) device, etc. The vehicle 150 may input data into computing component 110. The computing component 110 may perform one or more available operations on the input data to generate outputs, such as detecting and identifying lanes. The vehicle 150 may further display the outputs on a Graphical User Interface (GUI). The GUI may be on the vehicle 150 and may display the outputs as a two-dimensional (2D) and three-dimensional (3D) layout and map showing the various outputs generated by algorithms, such as ML algorithms, based on various input data, such as sensor data of road conditions, environmental conditions, lane markers, traffic, speed of vehicles, direction of vehicles, obstructions, and objects from vehicles and roads.

The computing system 110 in the illustrated example may include one or more processors and logic 130 that implements instructions to carry out the functions of the computing component 110, for example, identifying, based on sensor data from a plurality of other vehicles that traveled on a road segment, a plurality of lane-level patterns for the plurality of other vehicles; assigning each vehicle of the plurality of other vehicles to one of the lane-level patterns to sort the vehicles of the plurality of other vehicles into one or more clusters of vehicles; determining a lane identification for each cluster of vehicles; generating a lane identification distribution for a vehicle 150 based on sensor data of the vehicle 150 and the lane identification for each cluster of vehicles; and estimating a lane identification for the vehicle 150 based on the generated lane identification distribution. The computing component 110 may store, in a database 120, details regarding scenarios or conditions in which some algorithms, image datasets, and assessments are performed and used to detect and identify lanes. Some of the scenarios or conditions will be illustrated in the subsequent figures.

A processor may include one or more GPUs, CPUs, microprocessors or any other suitable processing system. Each of the one or more processors may include one or more single core or multicore processors. The one or more processors may execute instructions stored in a non-transitory computer readable medium. Logic 130 may contain instructions (e.g., program logic) executable by the one or more processors to execute various functions of computing component 110. Logic 130 may contain additional instructions as well, including instructions to transmit data to, receive data from, and interact with vehicle 150.

ML can refer to methods that, through the use of algorithms, are able to automatically extract intelligence or rules from training data sets and capture the same in informative models. In turn, those models are capable of making predictions based on patterns or inferences gleaned from subsequent data input into a trained model. According to implementations of the disclosed technology, the ML algorithm comprises, among other aspects, algorithms implementing a Gaussian process and the like. The ML algorithms disclosed herein may be supervised and/or unsupervised depending on the implementation. The ML algorithms may emulate the observed characteristics and components of roads, vehicles and drivers to better evaluate road conditions, evaluate driving patterns, and determine and identify lanes of a road to accurately navigate vehicles.

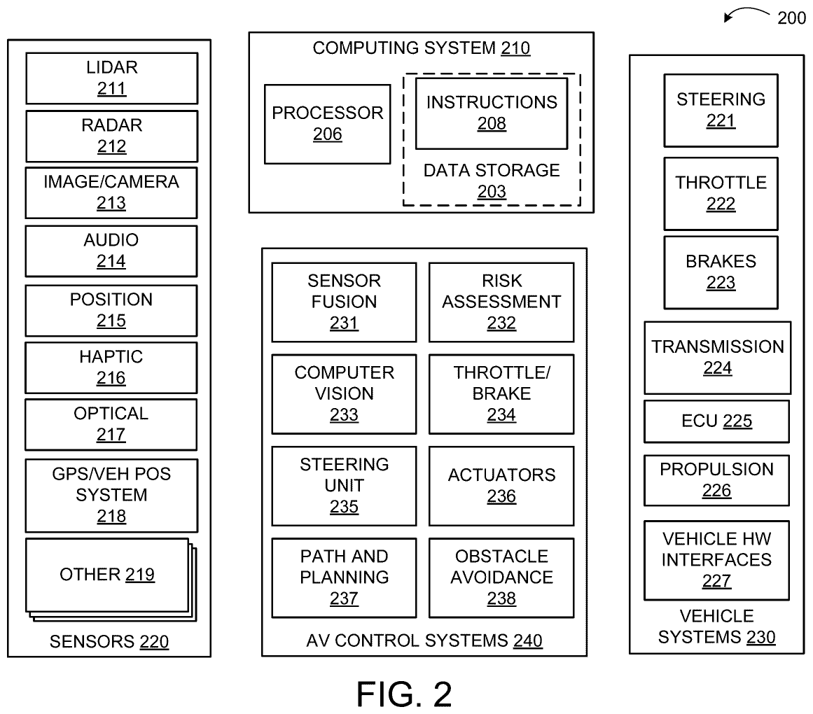

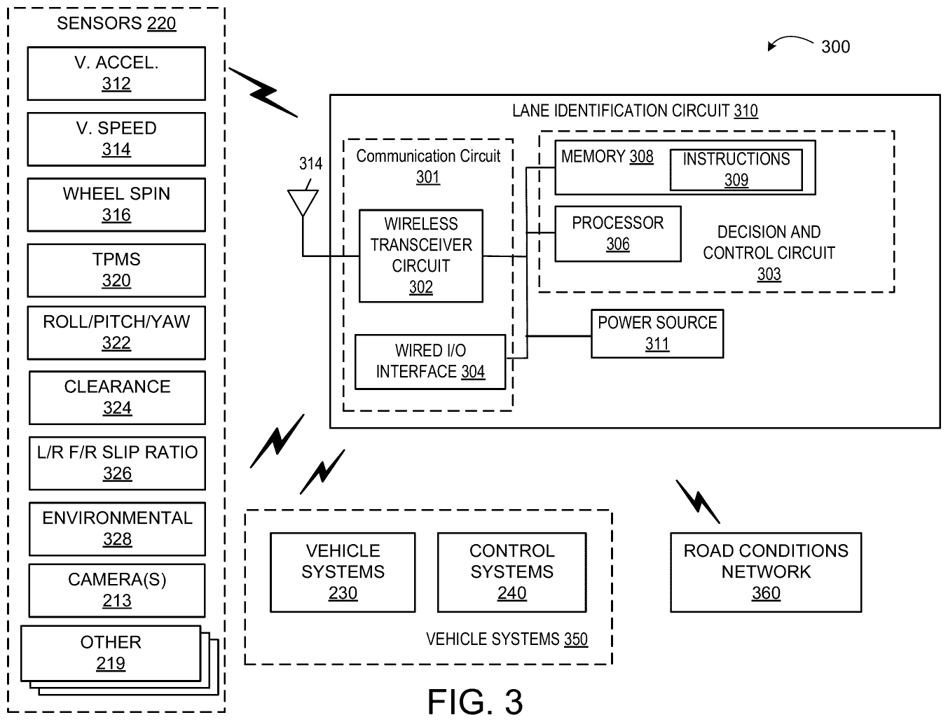

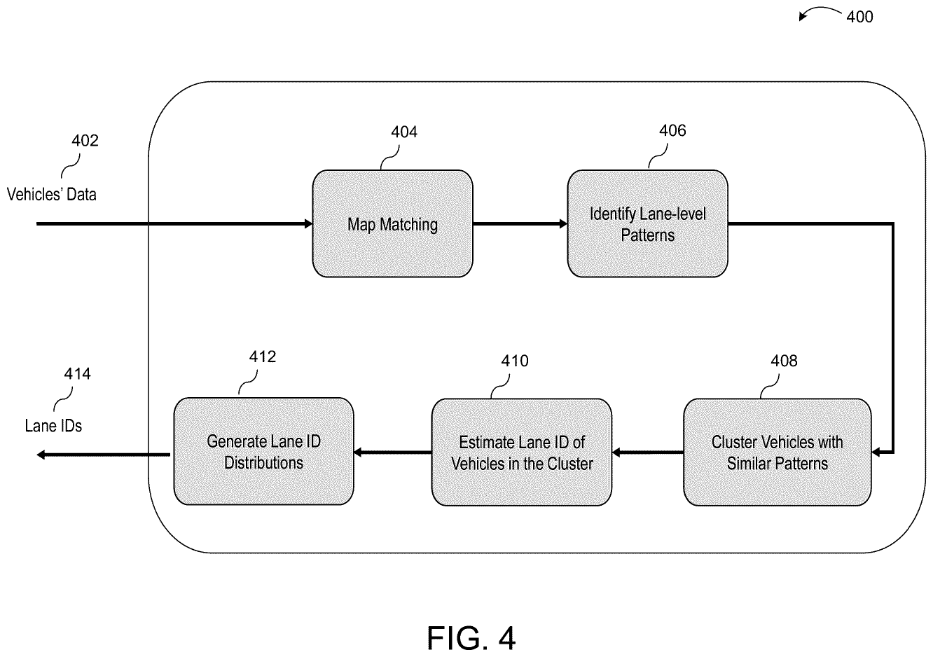

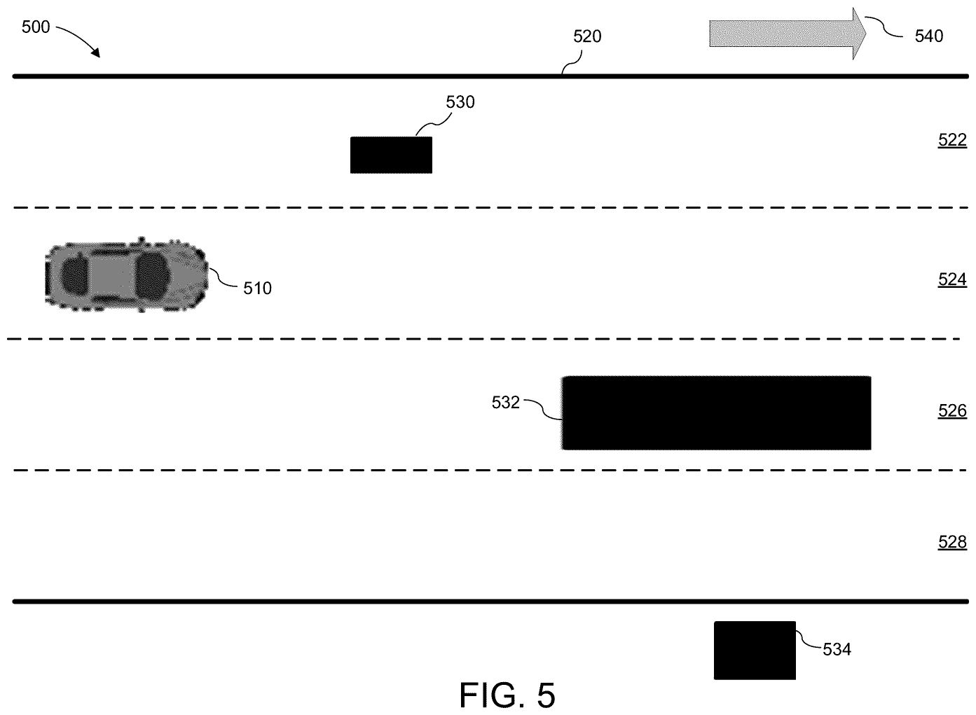

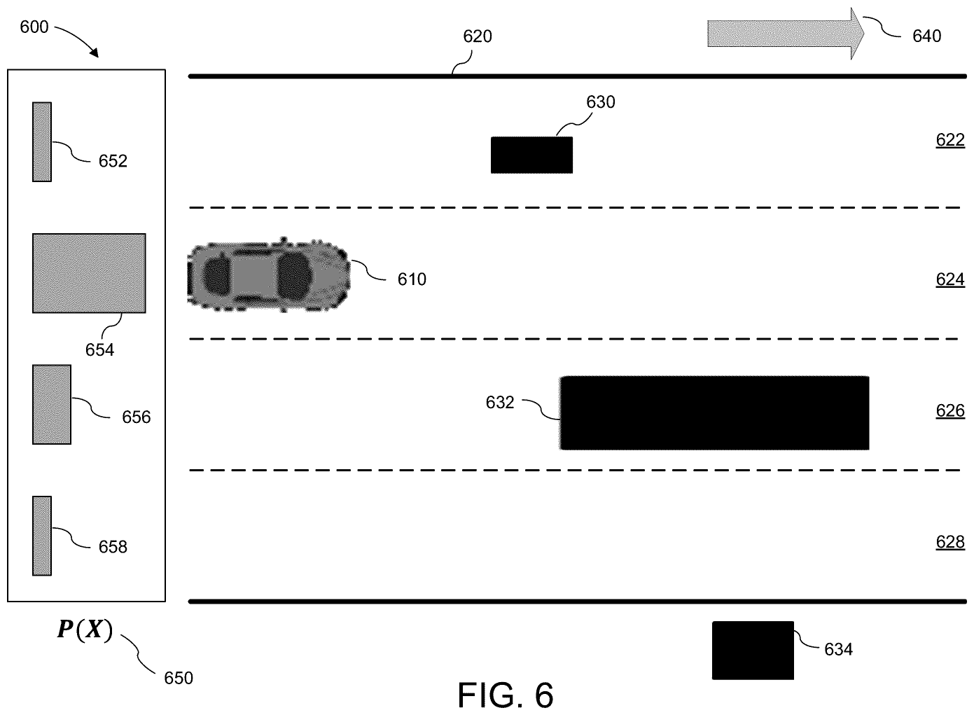

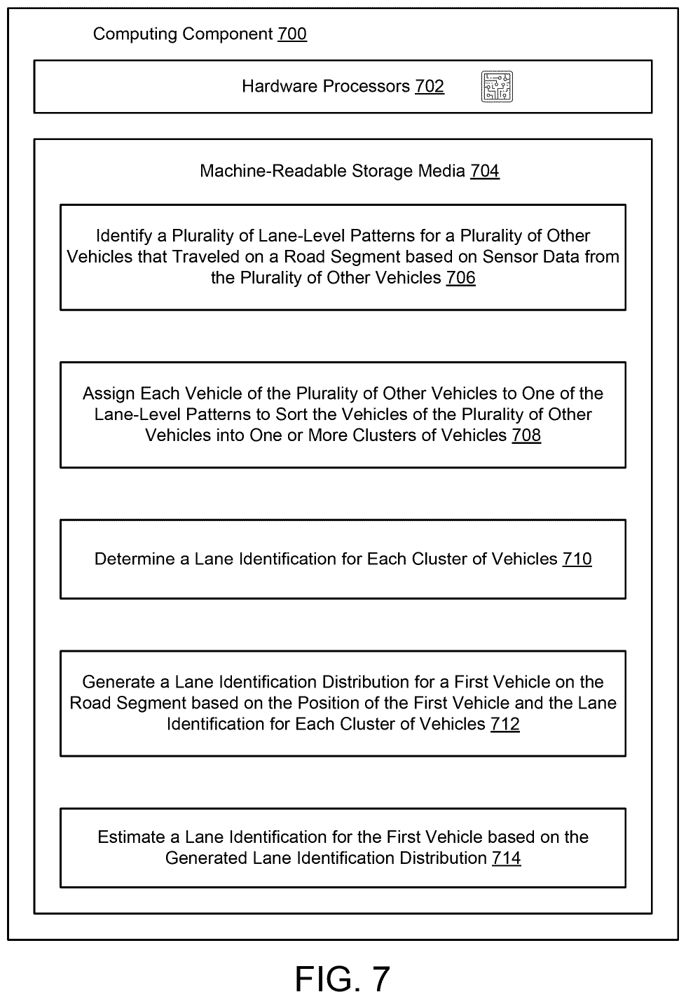

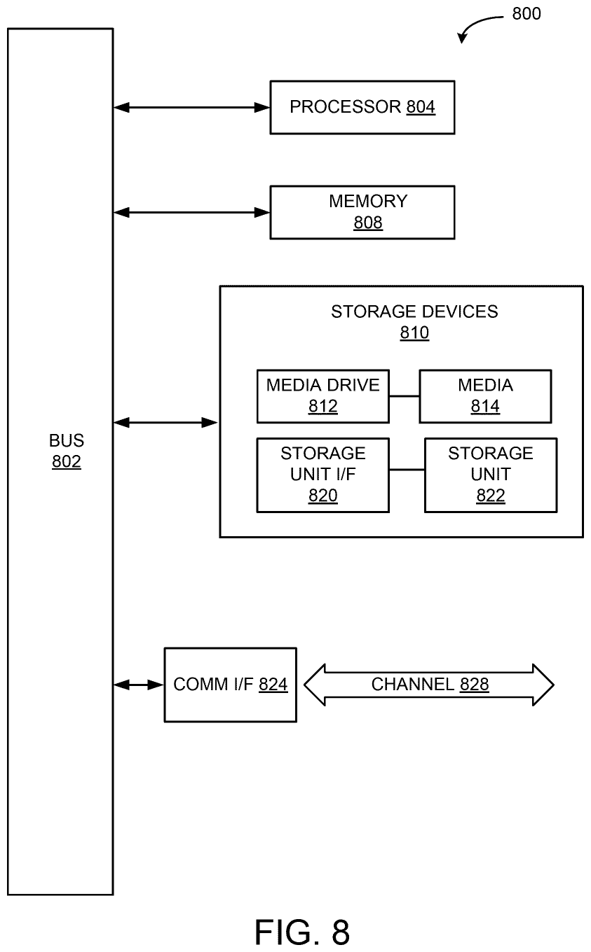

Although one example computing system 110 is illustrated in FIG. 1, in various embodiments multiple computing systems 110 can be included. Additionally, one or more systems and subsystems of computing system 100 can include its own dedicated or shared computing component 110, or a variant thereof. Accordingly, although computing system 100 is illustrated as a discrete computing system, this is for ease of illustration only, and computing system 100 can be distributed among various systems or components. The computing component 110 may be, for example, the computing system 210 of FIG. 2, the lane identification system 300 of FIG. 3, the process 400 of FIG. 4, the lane identification system 500 of FIG. 5, the lane identification system 600 of FIG. 6, the computing component 700 of FIG. 7 and the computing component 800 of FIG. 8.

FIG. 2 illustrates an example connected vehicle 200, such as an autonomous, semi-autonomous or manual vehicle, with which applications of the disclosed technology may be implemented. As described herein, vehicle 200 can refer to a vehicle, such as an automobile, truck, motorcycle, bicycle, scooter, moped, recreational vehicle and other like on- or off-road vehicles, that may include an autonomous, semi-autonomous and manual operation. The vehicle 200 may include components, such as a computing system 210, sensors 220, vehicle systems 230, and AV control systems 240. Either of the computing system 210, sensors 220, vehicle systems 230, and AV control systems 240 can be part of an automated vehicle system/advanced driver assistance system (ADAS). ADAS can provide navigation control signals (e.g., control signals to actuate the vehicle and operate one or more vehicle systems 230 as shown in FIG. 2) for the vehicle to navigate a variety of situations. As used herein, ADAS can be an autonomous vehicle control system adapted for any level of vehicle control and driving autonomy. For example, the ADAS can be adapted for level 1, level 2, level 3, level 4, and level 5 autonomy (according to SAE standard). ADAS can allow for control mode blending (i.e., blending of autonomous and assisted control modes with human driver control). ADAS can correspond to a real-time machine perception system for vehicle actuation in a multi-vehicle environment. Vehicle 200 may include a greater or fewer quantity of systems and subsystems, and each could include multiple elements. Accordingly, one or more of the functions of the technology disclosed herein may be divided into additional functional or physical components, or combined into fewer functional or physical components. Additionally, although the systems and subsystems illustrated in FIG. 2 are shown as being partitioned in a particular way, the functions of vehicle 200 can be partitioned in other ways. For example, various vehicle systems and subsystems can be combined in different ways to share functionality.

Sensors 220 may include a plurality of different sensors to gather data regarding vehicle 200, its operator, its operation and its surrounding environment. Although various sensors are shown, it can be understood that systems and methods for detecting and responding to intervening obstacles may not require many sensors. It can also be understood that system and methods described herein can be augmented by sensors off the vehicle 200. In this example, sensors 220 include light detection and ranging (LiDAR) sensor 211, radar sensor 212, image sensors 213 (i.e., a camera), audio sensors 214, position sensor 215, haptic sensor 216, optical sensor 217, a Global Positioning System (GPS) or other vehicle positioning system 218, and other like distance measurement and environment sensing sensors 219. One or more of the sensors 220 may gather data, such as road conditions data, and send that data to the vehicle ECU or other processing unit. Sensors 220 (and other vehicle components) may be duplicated for redundancy.

Distance measuring sensors such as LiDAR sensor 211, radar sensor 212, IR sensors and other like sensors can be used to gather data to measure distances and closing rates to various external objects such as other vehicles, roads, traffic signs, pedestrians, light poles and other objects. Image sensors 213 can include one or more cameras or other image sensors to capture images of the environment around the vehicle, such as road surfaces, as well as internal to the vehicle. Information from image sensors 213 (e.g., camera) can be used to determine information about the environment surrounding the vehicle 200 including, for example, information regarding road surfaces and other objects surrounding vehicle 200. For example, image sensors 213 may be able to recognize specific vehicles (e.g. color, vehicle type), landmarks or other features (including, e.g., street signs, traffic lights, etc.), slope of the road, lines on the road, damages and other potentially hazardous conditions to the road, curbs, objects to be avoided (e.g., other vehicles, pedestrians, bicyclists, etc.) and other landmarks or features. Information from image sensors 213 can be used in conjunction with other information such as map data, or information from positioning system 218 to determine, refine, or verify vehicle (ego vehicle or another vehicle) location as well as detect obstructions and identify lanes of a road.

Vehicle positioning system 218 (e.g., GPS or other positioning system) can be used to gather position information about a current location of the vehicle as well as other positioning or navigation information, such as the positioning information about a current location and direction of movement of the vehicle according to a particular road condition.

Other sensors 219 may be provided as well. Other sensors 219 can include vehicle acceleration sensors, vehicle speed sensors, wheelspin sensors (e.g., one for each wheel), a tire pressure monitoring sensor (e.g., one for each tire), vehicle clearance sensors, left-right and front-rear slip ratio sensors, and environmental sensors (e.g. to detect weather, traction conditions, or other environmental conditions). Other sensors 219 can be further included for a given implementation of ADAS. Various sensors 220, such as other sensors 219, may be used to provide input to computing system 210 and other systems of vehicle 200 so that the systems have information useful to detect and identify lanes.

AV control systems 240 may include a plurality of different systems/subsystems to control operation of vehicle 200. In this example, AV control systems 240 can include, autonomous driving module (not shown), sensor fusion module 231, risk assessment module 232, computer vision module 233, throttle and brake control unit 234, steering unit 235, actuator(s) 236, path and planning module 237, and obstacle avoidance module 238. Sensor fusion module 231 can be included to evaluate data from a plurality of sensors, including sensors 220. Sensor fusion module 231 may use computing system 210 or its own computing system to execute algorithms to assess inputs from the various sensors.

Throttle and brake control unit 234 can be used to control actuation of throttle and braking mechanisms of the vehicle to accelerate, slow down, stop or otherwise adjust the speed of the vehicle. For example, the throttle unit can control the operating speed of the engine or motor used to provide motive power for the vehicle. Likewise, the brake unit can be used to actuate brakes (e.g., disk, drum, etc.) or engage regenerative braking (e.g., such as in a hybrid or electric vehicle) to slow or stop the vehicle.

Steering unit 235 may include any of a number of different mechanisms to control or alter the heading of the vehicle. For example, steering unit 235 may include the appropriate control mechanisms to adjust the orientation of the front or rear wheels of the vehicle to accomplish changes in direction of the vehicle during operation. Electronic, hydraulic, mechanical or other steering mechanisms may be controlled by steering unit 235.

Computer vision module 233 may be included to process image data (e.g., image data captured from image sensors 213, or other image data) to evaluate the environment within or surrounding the vehicle. For example, algorithms operating as part of computer vision module 233 can evaluate still or moving images to determine features and landmarks (e.g., road pavements, lines of the road, damages and other potentially hazardous conditions on the road, road signs, traffic lights, lane markings and other road boundaries, etc.), obstacles (e.g., pedestrians, bicyclists, other vehicles, other obstructions in the path of the subject vehicle) and other objects. The system can include video tracking and other algorithms to recognize objects such as the foregoing, estimate their speed, map the surroundings, and so on. Computer vision module 233 may be able to model the road traffic vehicle network, predict incoming hazards and obstacles, predict road hazard, and determine one or more contributing factors to identifying obstructions. Computer vision module 233 may be able to perform depth estimation, image/video segmentation, camera localization, and object classification according to various classification techniques (including by applied neural networks).

Path and planning module 237 may be included to compute a desired path for vehicle 200 based on input from various other sensors and systems. For example, path and planning module 237 can use information from positioning system 218, sensor fusion module 231, computer vision module 233, obstacle avoidance module 238 (described below) and other systems (e.g., AV control systems 240, sensors 220, and vehicle systems 230) to determine a safe path to navigate the vehicle along a segment of a desired route. Path and planning module 237 may also be configured to dynamically update the vehicle path as real-time information is received from sensors 220 and other control systems 240.

Obstacle avoidance module 238 can be included to determine control inputs necessary to avoid obstacles and obstructions detected by sensors 220 or AV control systems 240. Obstacle avoidance module 238 can work in conjunction with path and planning module 237 to determine an appropriate path to avoid and navigate around obstacles and obstructions.

Path and planning module 237 (either alone or in conjunction with one or more other module of AV Control system 240, such as obstacle avoidance module 238, computer vision module 233, and sensor fusion module 231) may also be configured to perform and coordinate one or more vehicle maneuvers. Example vehicle maneuvers can include at least one of a path tracking, stabilization and collision avoidance maneuver. With connected vehicles, such as vehicles selected to identify lanes of a road, vehicle maneuvers can be performed at least partially cooperatively between the connected vehicles to gather a sufficient amount of data of the lanes of the road. A sufficient amount of data of lanes of a road may include collecting data of the obstructions on each lane of a road, at various angles and perspectives. Each different type of obstruction may warrant a different amount of data to be collected and analyzed to make the needed determinations of the obstruction. A sufficient amount of data of lanes of a road may further include environmental conditions, road conditions, lane markers, traffic, speed of vehicles, maneuvers of vehicles, and objects on or relating to each lane of a road. Hence, those of ordinary skill in the art will understand what sufficient means in the context of collecting a sufficient amount of data of a lane of a road.

Vehicle systems 230 may include a plurality of different systems/subsystems to control operation of vehicle 200. In this example, vehicle systems 230 include steering system 221, throttle system 222, brakes 223, transmission 224, electronic control unit (ECU) 225, propulsion system 226 and vehicle hardware interfaces 227. The vehicle systems 230 may be controlled by AV control systems 240 in autonomous, semi-autonomous or manual mode of vehicle 200. For example, in autonomous or semi-autonomous mode, AV control systems 240, alone or in conjunction with other systems, can control vehicle systems 230 to operate the vehicle in a fully or semi-autonomous fashion. When control is assumed, computing system 210 and AV control system 240 can provide vehicle control systems to vehicle hardware interfaces for controlled systems such as steering angle 221, brakes 223, throttle 222, or other hardware interfaces 227, such as traction force, turn signals, horn, lights, etc. This may also include an assist mode in which the vehicle takes over partial control or activates ADAS controls (e.g., AC control systems 240) to assist the driver with vehicle operation.

Computing system 210 in the illustrated example includes a processor 206, and memory 203. Some or all of the functions of vehicle 200 may be controlled by computing system 210. Processor 206 can include one or more GPUs, CPUs, microprocessors or any other suitable processing system. Processor 206 may include one or more single core or multicore processors. Processor 206 executes instructions 208 stored in a non-transitory computer readable medium, such as memory 203.

Memory 203 may contain instructions (e.g., program logic) executable by processor 206 to execute various functions of vehicle 200, including those of vehicle systems and subsystems. Memory 203 may contain additional instructions as well, including instructions to transmit data to, receive data from, interact with, and control one or more of the sensors 220, AV control systems 240 and vehicle systems 230. In addition to the instructions, memory 203 may store data and other information used by the vehicle and its systems and subsystems for operation, including operation of vehicle 200 in the autonomous, semi-autonomous or manual modes. For example, memory 203 can include data that has been communicated to the ego vehicle (e.g. via V2V communication), mapping data, a model of the current or predicted road traffic vehicle network, vehicle dynamics data, computer vision recognition data, and other data which can be useful for the execution of one or more vehicle maneuvers, for example by one or more modules of the AV control systems 240.

Although one computing system 210 is illustrated in FIG. 2, in various applications multiple computing systems 210 can be included. Additionally, one or more systems and subsystems of vehicle 200 can include its own dedicated or shared computing system 210, or a variant thereof. Accordingly, although computing system 210 is illustrated as a discrete computing system, this is for ease of illustration only, and computing system 210 can be distributed among various vehicle systems or components.

Vehicle 200 may also include a (wireless or wired) communication system (not illustrated) to communicate with other vehicles, infrastructure elements, cloud components and other external entities using any of a number of communication protocols including, for example, V2V (vehicle-to-vehicle), V2I (vehicle-to-infrastructure) and V2X (vehicle-to-everything) protocols. Such a wireless communication system may allow vehicle 200 to receive information from other objects including, for example, map data, data regarding infrastructure elements, data regarding operation and intention of surrounding vehicles, and so on. A wireless communication system may allow vehicle 200 to receive updates to data that can be used to execute one or more vehicle control modes, and vehicle control algorithms as discussed herein. Wireless communication system may also allow vehicle 200 to transmit information to other objects and receive information from other objects (such as other vehicles, user devices, or infrastructure). In some applications, one or more communication protocol or dictionaries can be used, such as the SAE J2935 V2X Communications Message Set Dictionary. In some applications, the communication system may be useful in retrieving and sending one or more data useful in detecting and identifying lanes, as disclosed herein.

Communication system can be configured to receive data and other information from sensors 220 that is used in determining whether and to what extent control mode blending should be activated. Additionally, communication system can be used to send an activation signal or other activation information to various vehicle systems 230 and AV control systems 240 as part of controlling the vehicle. For example, communication system can be used to send signals to one or more of the vehicle actuators 236 to control parameters, for example, maximum steering angle, throttle response, vehicle braking, torque vectoring, and so on.

In some applications, computing functions for various applications disclosed herein may be performed entirely on computing system 210, distributed among two or more computing systems 210 of vehicle 200, performed on a cloud-based platform, performed on an edge-based platform, or performed on a combination of the foregoing.

Path and planning module 237 can allow for executing one or more vehicle control mode(s), and vehicle control algorithms in accordance with various implementations of the systems and methods disclosed herein.

In operation, path and planning module 237 (e.g., by a driver intent estimation module, not shown) can receive information regarding human control input used to operate the vehicle. As described above, information from sensors 220, actuators 236 and other systems can be used to determine the type and level of human control input. Path and planning module 237 can use this information to predict driver action. Path and planning module 237 can use this information to generate a predicted path and model the road traffic vehicle network. This may be useful in evaluating road conditions, and determining and identifying lanes. As also described above, information from sensors, and other systems can be used to evaluate road conditions, evaluate driving patterns, and determine and identify lanes of a road. Eye state tracking, attention tracking, or intoxication level tracking, for example, can be used to determine vehicle movement patterns according to inherent human behavior. It can be understood that the driver state can contribute to identifying lanes as disclosed herein. Driver state can be provided to a risk assessment module 232 to determine the level of risk associated with a vehicle operation, and detecting and identifying lanes. Although not illustrated in FIG. 2, where the assessed risk contributes to determining vehicle movement patterns according to inherent human behaviors, a lane identification strategy may be generated and provided to vehicle 200 to identify lanes of a road. Aspects of generating a lane identification strategy to identify lanes of a road will be disclosed with reference to subsequent figures.

Path and planning module 237 can receive state information such as, for example from visibility maps, traffic and weather information, hazard maps, and local map views. Information from a navigation system can also provide a mission plan including maps and routing to path and planning module 237.

The path and planning module 237 (e.g., by a driver intent estimation module, not shown) can receive this information and predict behavior characteristics within a future time horizon. This information can be used by path and planning module 237 for executing one or more planning decisions. Planning decisions can be based on one or more policy (such as defensive driving policy). Planning decisions can be based on one or more level of autonomy, connected vehicle actions, one or more policy (such as defensive driving policy, cooperative driving policy, such as swarm or platoon formation, leader following, etc.). Path and planning module 237 can generate an expected model for the road traffic hazards and assist in creating a predicted traffic hazard level and verification strategy for vehicles to implement.

Path and planning module 237 can receive risk information from risk assessment module 232. Path and planning module 237 can receive vehicle capability and capacity information from one or more vehicle systems 230. Vehicle capability can be assessed, for example, by receiving information from vehicle hardware interfaces 227 to determine vehicle capabilities and identify a reachable set model. Path and planning module 237 can receive surrounding environment information (e.g., from computer vision module 233, and obstacle avoidance module 238). Path and planning module 237 can apply risk information and vehicle capability and capacity information to trajectory information (e.g., based on a planned trajectory and driver intent) to determine a safe or optimized trajectory for the vehicle given the drivers intent, policies (e.g. safety or vehicle cooperation policies), communicated information, given one or more obstacles in the surrounding environment, and road conditions. This trajectory information can be provided to controller (e.g., ECU 225) to provide partial or full vehicle control in the event of a risk level above threshold. A signal from risk assessment module 232 can be used generate countermeasures described herein. A signal from risk assessment module 232 can trigger ECU 225 or another AV control system 240 to take over partial or full control of the vehicle.

FIG. 3 illustrates an example architecture for lane identification described herein. Referring now to FIG. 3, in this example, a lane identification system 300 includes a lane identification circuit 310, a plurality of sensors 220, and a plurality of vehicle systems 350. Also included are various elements of road conditions network 360 with which the lane identification system 300 can communicate. It can be understood that a road conditions network 360 can include various elements that are navigating and important in navigating a road conditions network, such as vehicles, pedestrians (with or without connected devices that can include aspects of lane identification system 300 disclosed herein), or infrastructure (e.g. traffic signals, sensors, such as traffic cameras, databases, central servers, weather sensors). Other elements of the road conditions network 360 can include connected elements at workplaces, or the home (such as vehicle chargers, connected devices, appliances, etc.).

Lane identification system 300 can be implemented as and include one or more components of the vehicle 200 shown in FIG. 2. Sensors 220, vehicle systems 350, and elements of road conditions network 360, can communicate with the lane identification circuit 310 via a wired or wireless communication interface. As previously alluded to, elements of road conditions network 360 can correspond to connected or unconnected devices, infrastructure (e.g. traffic signals, sensors, such as traffic cameras, weather sensors), vehicles, pedestrians, obstacles, etc. that are in a broad or immediate vicinity of ego-vehicle (e.g., vehicle 200) or otherwise important to the navigation of the road conditions network (such as remote infrastructure). Although sensors 220, vehicle systems 350, and road conditions network 360, are depicted as communicating with lane identification circuit 310, they can also communicate with each other, as well as with other vehicle systems 350 and directly with element of a road conditions network 360. Data as disclosed herein can be communicated to and from the lane identification circuit 310. For example, various infrastructure (example element of road conditions network 360) can include one or more databases, such as vehicle crash data or weather data. This data can be communicated to the circuit 310, and such data can be updated based on outcomes for one or more maneuvers or navigation of the road conditions network, vehicle telematics, driver state (physical and mental), vehicle data from sensors 220 (e.g., tire pressure or brake status) from the vehicle. Similarly, traffic data, vehicle state data, time of travel, demographics data for drivers can be retrieved and updated. All of this data can be included in and contribute to predictive analytics (e.g., by machine learning) of accident possibility, and determinations of road conditions and poor, hazard road conditions. Similarly, models, circuits, and predictive analytics can be updated according to various outcomes.

Lane identification circuit 310 can evaluate road conditions of lanes and driving patterns of vehicles, detect lanes of a road, and generate a lane identification distribution to identify a lane on a road that a vehicle is traversing as described herein. As will be described in more detail herein, the identification of lanes of a road can have one or more contributing factors. Various sensors 220, vehicle systems 350, and road conditions network 360 elements may contribute to gathering data for evaluating road conditions of lanes, evaluating driving patterns of vehicles, and identify lanes of a road. For example, the lane identification circuit 310 can include at least one of a lane identification distribution detection and response circuit. The lane identification circuit 310 can be implemented as an ECU or as part of an ECU such as, for example electronic control unit 225. In other applications, lane identification circuit 310 can be implemented independently of the ECU, for example, as another vehicle system.

Lane identification circuit 310 can be configured to evaluate road conditions of lanes and driving patterns of vehicles, detect lanes of a road, generate a lane identification distribution to identify probabilities for each lane on a road that a vehicle is estimated to be traversing, and appropriately respond. Lane identification circuit 310 may include a communication circuit 301 (including either or both of a wireless transceiver circuit 302 with an associated antenna 314 and wired input/output (I/O) interface 304 in this example), a decision and control circuit 303 (including a processor 306 and memory 308 in this example) and a power source 311 (which can include power supply). It is understood that the disclosed lane identification circuit 310 can be compatible with and support one or more standard or non-standard messaging protocols.

Components of lane identification circuit 310 are illustrated as communicating with each other via a data bus, although other communication in interfaces can be included. Decision and control circuit 303 can be configured to control one or more aspects of lane identification and response. Decision and control circuit 303 can be configured to execute one or more steps described with reference to FIG. 4 and FIG. 7.

Processor 306 can include a GPU, CPU, microprocessor, or any other suitable processing system. The memory 308 may include one or more various forms of memory or data storage (e.g., flash, RAM, etc.) that may be used to store the calibration parameters, images (analysis or historic), point parameters, instructions and variables for processor 306 as well as any other suitable information. Memory 308 can be made up of one or more modules of one or more different types of memory, and may be configured to store data and other information as well as operational instructions 309 that may be used by the processor 306 to execute one or more functions of lane identification circuit 310. For example, data and other information can include vehicle data, such as a determined familiarity of the driver with driving and the vehicle. The data can also include values for signals of one or more sensors 220 useful in detecting and identifying lanes. Operational instruction 309 can contain instructions for executing logical circuits, models, and methods as described herein.

Although the example of FIG. 3 is illustrated using processor and memory circuitry, as described below with reference to circuits disclosed herein, decision and control circuit 303 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a lane identification circuit 310. Components of decision and control circuit 303 can be distributed among two or more decision and control circuits 303, performed on other circuits described with respect to lane identification circuit 310, be performed on devices (such as cell phones) performed on a cloud-based platform (e.g. part of infrastructure), performed on distributed elements of the road conditions network 360, such as at multiple vehicles, user device, central servers, performed on an edge-based platform, and performed on a combination of the foregoing.

Communication circuit 301 may include either or both a wireless transceiver circuit 302 with an associated antenna 314 and a wired I/O interface 304 with an associated hardwired data port (not illustrated). As this example illustrates, communications with lane identification circuit 310 can include either or both wired and wireless communications circuits 301. Wireless transceiver circuit 302 can include a transmitter and a receiver (not shown), e.g., a lane identification broadcast mechanism, to allow wireless communications via any of a number of communication protocols such as, for example, WiFi (e.g. IEEE 802.11 standard), Bluetooth, near field communications (NFC), Zigbee, and any of a number of other wireless communication protocols whether standardized, proprietary, open, point-to-point, networked or otherwise. Antenna 314 is coupled to wireless transceiver circuit 302 and is used by wireless transceiver circuit 302 to transmit radio signals wirelessly to wireless equipment with which it is connected and to receive radio signals as well. These RF signals can include information of almost any sort that is sent or received by lane identification circuit 310 to/from other components of the vehicle, such as sensors 220, vehicle systems 350, infrastructure (e.g., servers cloud based systems), and other devices or elements of road conditions network 360. These RF signals can include information of almost any sort that is sent or received by vehicle.

Wired I/O interface 304 can include a transmitter and a receiver (not shown) for hardwired communications with other devices. For example, wired I/O interface 304 can provide a hardwired interface to other components, including sensors 220, vehicle systems 350. Wired I/O interface 304 can communicate with other devices using Ethernet or any of a number of other wired communication protocols whether standardized, proprietary, open, point-to-point, networked or otherwise.

Power source 311 such as one or more of a battery or batteries (such as, e.g., Li-ion, Li-Polymer, NiMH, NiCd, NiZn, and NiH₂, to name a few, whether rechargeable or primary batteries), a power connector (e.g., to connect to vehicle supplied power, another vehicle battery, alternator, etc.), an energy harvester (e.g., solar cells, piezoelectric system, etc.), or it can include any other suitable power supply. It is understood power source 311 can be coupled to a power source of the vehicle, such as a battery and alternator. Power source 311 can be used to power the lane identification circuit 310.

Sensors 220 can include one or more of the previously mentioned sensors 220. Sensors 220 can include one or more sensors that may or not otherwise be included on a standard vehicle (e.g., vehicle 200) with which the lane identification circuit 310 is implemented. In the illustrated example, sensors 220 include vehicle acceleration sensors 312, vehicle speed sensors 314, wheelspin sensors 316 (e.g., one for each wheel), a tire pressure monitoring system (TPMS) 320, accelerometers such as a 3-axis accelerometer 322 to detect roll, pitch and yaw of the vehicle, vehicle clearance sensors 324, left-right and front-rear slip ratio sensors 326, environmental sensors 328 (e.g., to detect weather, salinity or other environmental conditions), and camera(s) 213 (e.g. front rear, side, top, bottom facing). Additional sensors 219 can also be included as may be appropriate for a given implementation lane identification system 300.

Vehicle systems 350 can include any of a number of different vehicle components or subsystems used to control or monitor various aspects of the vehicle and its performance. For example, it can include any or all of the aforementioned vehicle systems 230 and control systems 240 shown in FIG. 2. In this example, the vehicle systems 350 may include a GPS or other vehicle positioning system 218.

During operation, lane identification circuit 310 can receive information from various vehicle sensors 220, vehicle systems 350, and road conditions network 360 to identify lanes. Also, the driver, owner, and operator of the vehicle may manually trigger one or more processes described herein for evaluating road conditions of lanes and driving patterns of vehicles, detecting lanes of a road, and generating a lane identification distribution to identify a lane on a road that a vehicle is traversing. Communication circuit 301 can be used to transmit and receive information between the lane identification circuit 310, sensors 220 and vehicle systems 350. Also, sensors 220 and lane identification circuit 310 may communicate with vehicle systems 350 directly or indirectly (e.g., via communication circuit 301 or otherwise). Communication circuit 301 can be used to transmit and receive information between lane identification circuit 310, one or more other systems of a vehicle 200, but also other elements of a road conditions network 360, such as vehicles, devices (e.g., mobile phones), systems, networks (such as a communications network and central server), and infrastructure.

In various applications, communication circuit 301 can be configured to receive data and other information from sensors 220 and vehicle systems 350 that is used in detecting and identifying lanes. As one example, when data is received from an element of road conditions network 360 (such as from a driver's user device), communication circuit 301 can be used to send an activation signal and activation information to one or more vehicle systems 350 or sensors 220 for the vehicle to detect and identify the lane of a road it is traversing. For example, it may be useful for vehicle systems 350 or sensors 220 to provide data useful in detecting and identifying lanes. Alternatively, lane identification circuit 310 can be continuously receiving information from vehicle system 350, sensors 220, other vehicles, devices and infrastructure (e.g., those that are elements of road conditions network 360). Further, upon identifying lanes of a road, communication circuit 301 can send a signal to other components of the vehicle, infrastructure, or other elements of the road conditions network based on the identification of the lanes. For example, the communication circuit 301 can send a signal to a vehicle system 350 that indicates a control input for performing one or more vehicle movement patterns to navigate around any obstructions on roads according to the determined lane identifications. In some applications upon identifying lanes of a road, the driver's control of the vehicle can be prohibited, and control of the vehicle can be offloaded to the ADAS. In more specific examples, upon identifying a lane of travel of a vehicle (e.g., by sensors 220, and vehicle system 350 or by elements of the road conditions network 360), one or more signals can be sent to a vehicle system 350, so that an assist mode can be activated and the vehicle can control one or more of vehicle systems 230 (e.g., steering system 221, throttle system 222, brakes 223, transmission 224, ECU 225, propulsion system 226, suspension, and powertrain).

The examples of FIGS. 2 and 3 are provided for illustration purposes only as examples of vehicle 200 and lane identification system 300 with which applications of the disclosed technology may be implemented. One of ordinary skill in the art reading this description will understand how the disclosed applications can be implemented with vehicle platforms.

FIG. 4 illustrates an example process 400 that includes one or more steps that may be performed to detect and identify lanes. In some applications, the process 400 can be executed, for example by the computing component 110 of FIG. 1. In another application, the process 400 may be implemented as the computing component 110 of FIG. 1. In other applications, the process 400 may be implemented as, for example, the computing system 210 of FIG. 2, the lane identification system 300 of FIG. 3, the lane identification system 500 of FIG. 5, the lane identification system 600 of FIG. 6, the computing component 700 of FIG. 7, and the computing component 800 of FIG. 8. The process 400 may include a server. The process 400 may be implemented by one or more vehicles where the one or more vehicles may form a P2P or V2V network.

At step 402, the computing component 110 may receive data of a plurality of vehicles. An ego vehicle may be traveling on a road. The ego vehicle may include one or more sensors that may be used to collect data, including, for example, map data and sensor data, of the road that upon which the vehicle is traveling. The map data, which may be stored onboard the vehicle or obtained from the cloud or other infrastructure element, may include location, coordinates, population, landscape, landmark, terrain, territory, weather, temperature, humidity, pollution, habitat, and other environmental surroundings on, proximate to, and associated with the road that the vehicle is traveling on. The sensor data may include information on the condition of the road, damages to the road, hazardous features on the road, attributes of the road (i.e., the color, size, type and shape of the lane markers, number of lanes, etc.), environmental conditions, lane markers and marking within the lane, map, location, traffic, speed, direction, and objects on, proximate to, and associated with the road that is collected by the ego vehicle. An object on the road may include a pothole, crack, tire marking, faded road marking, debris, occlusion, road reflection, flooding, ice, fire, oil leak, uneven pavement, erosion, raveling, sign, pole, building, structure, pedestrian, animal, and vehicle. The environmental conditions. The environmental conditions may include location, coordinates, population, landscape, landmark, terrain, territory, weather, temperature, humidity, pollution, habitat, and other environmental surroundings on, proximate to, or associated with the road upon which the ego vehicle is traveling. The computing component 110 may receive map data and sensor data of the ego vehicle.

One or more vehicles that traversed or that are traversing a determined segment of the road on which the ego vehicle is traveling may be identified. The identification can be based on factors such as the timeframe that the other vehicles traversed the road segment. For example, the identification may be limited to vehicles that traveled on the same road segment within a given amount of time prior to the current time at which the ego vehicle is traveling on the road segment. This time window may be set as a predetermined amount of time and the predetermined amount of time may vary based on the circumstances or conditions. The identification of vehicles may also be based on a distance threshold to a position of interest of the ego vehicle. This may be determined, for example, based on the road segment (e.g., any vehicle within the identified road segment, or vehicles within the road segment that are also within a determined distance of a position of the ego vehicle), including one or more vehicles within a distance threshold to the position of the ego vehicle. The distance threshold may be a preset value. The distance threshold may vary according to the location of the ego vehicle as determined from the map data. The distance threshold may vary according to conditions and features of the road as determined from the sensor data. The distance threshold may be updated according to algorithms and models using data of vehicles. Many variations are possible.

The identified vehicles, hereinafter referred to as the subset of vehicles, may also include one or more vehicles enroute in the same direction on the road as the ego vehicle and that was previously at or proximate to the location of the ego vehicle within a time threshold. A vehicle may be determined to be enroute in the same direction on the road as the ego vehicle according to the vehicle's location and direction of movement. A vehicle may be determined to be enroute in the same direction on the road as the ego vehicle according to a GPS of the vehicle. The GPS of the vehicle may include instructions and directions of a route that the vehicle may follow to reach a particular destination. The instructions and directions of the route of the GPS may include the location of the vehicle. The location of the vehicle may be used to determine an amount of time that has passed since the vehicle was at or proximate to the present location of the ego vehicle. The time threshold may be a preset value. The time threshold may vary according to the location of the ego vehicle as determined from the map data. The time threshold may vary according to conditions and features of the road as determined from the sensor data. The time threshold may be updated according to algorithms and models using data of vehicles. Many variations are possible.

The subset of vehicles may further include one or more vehicles that have one or more sensors capable of collecting data of the road and the driving performance of the respective vehicle. One or more sensors, either individually or in combination, may be able to collect data on the road, such as sensor data, to determine conditions and features of the road. The one or more sensors, either individually or in combination, may be able to collect data on the driving performance of the respective vehicle to determine the driving pattern of the respective vehicle on the road. The one or more sensors of the vehicle used to collect data may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

The subset of vehicles may further include one or more vehicles based on performance data of the respective vehicle with regards to how accurately the respective vehicle follows navigation directions, avoids obstructions, and performs defensive driving. The subset of vehicles may further include one or more vehicles that are associated with a lane identification system, such as, for example, vehicles owned by municipality, including buses, ambulances, autonomous ego motions, city patrollers and the like.

Each of the identified subset of vehicles may communicate to one another using a P2P (peer-to-peer), or V2V or other communication protocol. The identified subset of vehicles may move as a convoy or a platoon, according to a navigation strategy, to collect data of the road and data of the subset of vehicles.

Each of the subset of vehicles may have its own sensor data. The sensor data of each of the subset of vehicles may include a direction, speed, driving pattern, location, road condition, map, location, traffic, object, and environmental condition that the respective one of the subset of vehicles encountered during its travel on the road. The computing component 110 may further receive the sensor data of the subset of vehicles.

At step 404, the computing component 110 may determine if map information of the ego vehicle matches map information of the subset of vehicles. The map data, sensor data, or both may be analyzed to determine a position of the ego vehicle on the road. The sensor data, map data, or both may be analyzed to determine a number of lanes on the road at the position of the ego vehicle. The data of the subset of vehicles may be analyzed to determine lane identification information of the road. Such lane identification information may be indicative of a map of the road. The map data and sensor data of the ego vehicle may be analyzed against the data of the subset of vehicles to determine that the map information of the road for each vehicle is identical. Determining that the map information of the road for each vehicle is identical may verify that the data of the subset of vehicles is relevant to the ego vehicle and the road the ego vehicle is currently traveling on.

At step 406, the computing component 110 may identify lane-level patterns. The data of the subset of vehicles may be analyzed to determine lane-level patterns for each of the vehicles on the road. A lane-level pattern may include information associated with a pattern performed and/or experienced by one or more vehicles on a particular lane on the road, such as, for example, a driving pattern, acceleration profile pattern, suspension pattern, speed pattern, detected object pattern, road condition pattern, traffic pattern, and direction pattern. Such information associated with a lane on the road may be considered as lane identification information. The lane identification information of a lane on the road may include a lane marker type (i.e., dashed, solid, white, yellow, double, etc.), flow of traffic, driving pattern, obstruction, object, and road condition of the respective lane on the road.

A lane-level pattern for a vehicle on the road may be used to identify and distinguish vehicles from each other, and in determining lane identification information of each lane on the road. For example, lane identification information may be analyzed to determine that a lane-level pattern for one or more vehicles on a road may have a slower flow of traffic than the other lanes on the road by about 20 miles an hour. The slower flow of traffic may be caused by a large semi-truck traveling that is carrying a heavy load of products. Lane identification information may be analyzed to determine that a lane-level pattern for one or more other vehicles on the same road may indicate that there is a fast flow of traffic until around a particular position on the road where vehicles move out of one lane and into another lane, either on the right or left of the particular lane. It may be determined that there is a pothole obstruction at the particular position on the road. The lane identification information may be analyzed to determine that a lane-level pattern for one or more different vehicles on the same road may have a fast flow of traffic and that these vehicles drive by objects on the left of the vehicles every few miles. The objects on the left of the vehicles may be determined to be speed limit signs. Many variations are possible.

At step 408, the computing component 110 may cluster vehicles with similar lane-level patterns. After analyzing the lane identification information to determine lane-level patterns, such as driving patterns, of vehicles on the road, the data of each vehicle of the subset of vehicles may be analyzed to determine a lane-level pattern of each respective vehicle. The lane-level pattern of each vehicle of the subset of vehicles may be analyzed to sort each of the subset of vehicles into clusters of vehicles so that each vehicle in a cluster may have a similar, if not the same, lane-level pattern to other vehicles in the same cluster. The vehicles of the subset of vehicles with lane-level patterns found to be similar, if not the same, may be clustered together.

At step 410, the computing component 110 may estimate lane identifications of vehicles in each cluster. The lane-level patterns of vehicles and lane identification information of the road may be analyzed to identify each lane on the road. For example, the lane-level patterns of vehicles and lane identification information associated with a first lane on the road may be analyzed to determine that there is dashed lane marker on the left side of the first lane and a solid lane marker on the right side of the first lane. The lane-level patterns of vehicles and lane identification information associated with a second lane on the road may be analyzed to determine that there is a dashed lane marker on both the right side and left side of the second lane. The lane-level patterns of vehicles and lane identification information associated with a third lane on the road may be analyzed to determine that there is dashed lane marker on the right side of the third lane and a solid lane marker on the left side of the third lane.

Analyzing the lane identification information of the road and the lane-level patterns of vehicles on the road may determine that there is a high probability that: (1) the vehicles traveling on the first lane, as referred to above, are in fact traveling on lane #3 on the road; (2) the vehicles traveling on the second lane, as referred to above, are in fact traveling on lane #2 on the road; and (3) the vehicles traveling on the third lane, as referred to above, are in fact traveling on lane #1 on the road, where the numbering of the lanes on the road are counted from left to right when facing in the direction of traffic, as shown by arrow 540.

At step 412, the computing component 110 may generate a lane identification distribution with lane identification probabilities for each lane of the road. The lane identification information of the road and the position of the ego vehicle on the road may be analyzed to generate a lane identification distribution, where the lane identification distribution includes lane identification probabilities for each lane and the lane identification probability of a particular lane is indicative of a probability that the ego vehicle is in the particular lane of the number of lanes on the road. The lane identification probability of each lane on the road may be a value between 0 and 1. The total value of the lane identification probabilities of all of the lanes on the road may equal 1. The lane on the road with the highest value of lane identification probability may be indicative of the lane on the road that the ego vehicle is most likely located in while traveling on the road.

The sensor data and the map data of the ego vehicle may be analyzed to determine the position of the ego vehicle on the road and features of the lane on the road upon which the ego vehicle is traveling. Features of a lane on the road that the ego vehicle may determine from its sensor data and map data may include lane marker types (i.e., dashed, solid, white, yellow, double, etc.), objects, obstructions, flow of traffic, etc. that are on or associated with the respective lane on the road. According to the lane identification information of each lane, and the sensor data and map data of the ego vehicle, a lane identification probability for lane #1 on the road may be determined to be 30%, a lane identification probability for lane #2 on the road may be determined to be 60%, and a lane identification probability for lane #3 on the road may be determined to be 10%. This means that according to the lane identification information of each lane, and the sensor data and map data of the ego vehicle, there is 30% estimate that the ego vehicle is in lane #1 on the road, a 60% estimate that the ego vehicle is in lane #2 on the road, and a 10% estimate that the ego vehicle is in lane #3 on the road. The lane identification distribution may include each of the lane identification probabilities for lanes #1, #2 and #3. The lane identification distribution may be indicative of the possibilities the ego vehicle is traveling on each lane on the road.

The lane identification probability of each lane on the road may be updated as the ego vehicle travels on the road. As the ego vehicle travels on the road, the ego vehicle may collect new sensor data and new map data that may update the position of the ego vehicle and information of the road at the updated position of the ego vehicle. New lane identification information may also be determined from data of the subset of vehicles at the updated position of the ego vehicle on the road. The new sensor data, new map data, and new lane identification information may all be analyzed to update the lane identification distribution and each lane identification probability of each lane on the road at the updated position of the ego vehicle on the road. The updated lane identification distribution may be indicative of a new set of lane identification probabilities that the ego vehicle is in each of the number of lanes on the road. The lane identification distribution may further be updated according to algorithms and models using data received from various vehicles that may not be included in the subset of vehicles.

At step 414, the computing component 110 may output a lane identification of the ego vehicle. The lane identification of the ego vehicle may be indicative of the lane on the road that the vehicle is currently traveling on. Analyzing the lane identification probability of each lane on the road according to the current position of the ego vehicle on the road may determine a lane identification for the ego vehicle. For example, based on the lane identification probability of each lane on the road, as mentioned above, the lane identification of the ego vehicle may be determined as lane #2 on the road. The lane identification distribution with the lane identification probabilities for each lane on the road, along with the lane identification for the ego vehicle, may be outputted to the ego vehicle, a vehicle monitoring system, a vehicle navigation system, etc.

Monitoring data of various vehicles traveling on a road may permit up-to-date lane identification information and road conditions, that may be analyzed to efficiently and accurately determine lane identifications of the road. The efficient and accurate determination of line identifications of the road may improve the navigation of vehicles traveling on the road and increase the avoidance of incidents and accidents occurring on the road.

For simplicity of description, the process 400 is described as being performed with respect to a single vehicle. It should be appreciated that, in a typical embodiment, the computing component 110 may manage the determination of lane identifications with respect to a plurality of vehicles, at various locations, on various roads, in short succession of one another. For example, in some embodiments, the computing component 110 can perform many, if not all, of the steps in process 400 on a plurality of vehicles on various roads as data is obtained from a plurality of vehicles.

FIG. 5 illustrates an example lane identification system 500. The lane identification system 500 may be configured to detect and identify lanes on a road. The lane identification system 500 may use one or more sensors of a vehicle, such as vehicle 510, and one or more sensors on a road, such as road 520, to collect data of road 520 and its lanes, such as lanes 522, 524, 526, and 528. One or more vehicles, such as vehicle 510, may be used to collect data to detect and identify lanes on a road, such as lanes 522, 524, 526, and 528 on road 520, by using the same lane identification system 500. Each of the vehicles used to collect data to detect and identify lanes on a road may each use a separate lane identification system 500 where each vehicle's respective lane identification system 500 may communicate to each other. Many variations are possible.

The lane identification system 500 may be used by one or more vehicles, such as vehicles 510, to detect and identify lanes on a road, such as lanes 522, 524, 526, and 528 on road 520. Vehicle 510 may include, for example, an automobile, truck, motorcycle, bicycle, scooter, moped, recreational vehicle and other like on- or off-road vehicles. Vehicle 510 may include, for example, an autonomous, semi-autonomous and manual operation. Vehicle 510 may each include one or more sensors that may be used to collect data of the road. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). One or more sensors of vehicle 510 may be used to observe areas of road 520 around the vehicle 510, such as in front of, behind, to the right side of and to the left side of vehicle 510, and collect data of road 520. Data of road 520 may be collected from the areas of the road observed by one or more sensors of vehicle 510. Data of road 520 may also be collected from the areas of the road observed by one or more sensors of other vehicles that are or did travel on road 520. Data of road 520 may further be collected from the areas of the road observed by one or more sensors of road 520. The lane identification system 500 may combine the road data collected by one or more sensors of one or more vehicles with road data collected by one or more sensors on one or more roads. Many variations are possible.

The data of the road 520 collected by one or more sensors of vehicles, including vehicle 510, and by one or more sensors on the road 520, may be used by the lane identification system 500 to analyze. As shown in FIG. 5, the lane identification system 500 may analyze the data of the road 520 to determine the road condition of each part of the road 520 that is observed by a vehicle. The lane identification system 500 may analyze the data of the road 520 collected by a vehicle, such as vehicle 510, to determine one or more attributes and characteristics of the road 520. Different attributes and characteristics of the road 520 may represent various road conditions. The road condition of a road may include formation on the condition of the road, damages to the road, hazardous features on the road, and attributes of the road (i.e., the color, size, number of lanes, lane markers, shape, etc.). Many variations are possible.

The lane identification system 500 may use the data of the road 520 collected, by one or more sensors of one or more vehicles, such as vehicle 510, and by one or more sensors on the road 520, to determine one or more attributes and characteristics of the road 520 to detect obstructions, objects, and other features on the road 520. Different attributes and characteristics of the road may represent various obstructions, objects, and other features. The lane identification system 500 may determine, from analyzing data of the road 520 collected by one or more sensors of one or more vehicles, including vehicle 510, and one or more sensors on the road 520, an obstruction 530, a road feature 532, and an object 534. An obstruction, such as obstructions 530, may include, for example, a pothole, crack, tire marking, faded road marking, debris, occlusion, road reflection, flooding, icy surface, oil leak, uneven pavement, erosion and raveling. A road feature, such as feature 532, may include, for example, flow of traffic, driving pattern, lane crossing, merging lane markers, slope on the road, and accident. An object, such as object 534, may include, for example, street signs, traffic lights, light poles, pedestrians, vehicles, bicycles, and buildings.

For example, the lane identification system 500 may analyze the data of the road 520 collected by vehicles, such as vehicle 510, to detect the obstruction 530, road feature 532, and object 534. The lane identification system 500 may determine, from the attributes and characteristics of the road 520, that obstructions 530 may be a pothole, road feature 532 may be an accident, and object 534 may be a speed limit sign. The obstructions, objects, road features, and the associated attributes and characteristics of a road, such as road 520 may be preset and stored in a database. The obstructions, objects, road features, and the associated attributes and characteristics of a road, such as road 520, may be updated according to algorithms and models using road conditions data received from various vehicles and various road sensors. Many variations are possible.

The lane identification system 500 may be implemented as the computing component 110 of FIG. 1, the computing system 210 of FIG. 2, the lane identification system 300 of FIG. 3, the process 400 of FIG. 4, the lane identification system 600 of FIG. 6, the computing component 700 of FIG. 7, and the computing component 800 of FIG. 8.

FIG. 6 illustrates an example lane identification system 600. To accurately detect and identify lanes of a road, such as road 620, lane identification information may be determined for each lane of road 620, such as lanes 622, 624, 626, and 628. To determine lane identification information, a subset of vehicles may be identified that traversed, or are traversing, the road that the ego vehicle is traveling on. The subset of vehicles may include, for example, automobiles, trucks, motorcycles, bicycles, scooters, mopeds, recreational vehicles and other like on- or off-road vehicles. The subset of vehicles may include, for example, an autonomous, semi-autonomous and manual operation. The subset of vehicles may include one or more vehicles within a distance threshold to the position of the ego vehicle. The distance threshold may be a preset value. The distance threshold may vary according to the location of the ego vehicle as determined from the map data. The distance threshold may vary according to conditions and features of the road as determined from the sensor data. The distance threshold may be updated according to algorithms and models using data of vehicles. Many variations are possible.

The subset of vehicles may also include one or more vehicles enroute in the same direction on the road as the ego vehicle and that was previously at or proximate to the location of the ego vehicle within a time threshold. A vehicle may be determined to be enroute in the same direction on the road as the ego vehicle according to the vehicle's location and direction of movement. A vehicle may be determined to be enroute in the same direction on the road as the ego vehicle according to a GPS of the vehicle. The GPS of the vehicle may include instructions and directions of a route that the vehicle may follow to reach a particular destination. The instructions and directions of the route of the GPS may include the location of the vehicle. The location of the vehicle may be used to determine an amount of time that has passed since the vehicle was at or proximate to the present location of the ego vehicle. The time threshold may be a preset value. The time threshold may vary according to the location of the ego vehicle as determined from the map data. The time threshold may vary according to conditions and features of the road as determined from the sensor data. The time threshold may be updated according to algorithms and models using data of vehicles. Many variations are possible.

The subset of vehicles may further include one or more vehicles that have one or more sensors capable of collecting data of the road and the driving performance of the respective vehicle. One or more sensors, either individually or in combination, may be able to collect data on the road, such as sensor data, to determine conditions and features of the road. The one or more sensors, either individually or in combination, may be able to collect data on the driving performance of the respective vehicle, such as sensor data, to determine the driving pattern of the respective vehicle on the road. The one or more sensors of the vehicle used to collect sensor data and driving data may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

The subset of vehicles may further include one or more vehicles based on performance data of the respective vehicle with regards to how accurately the respective vehicle follows navigation directions, avoids objects, and performs defensive driving. The subset of vehicles may further include one or more vehicles that are associated with a lane identification system, such as, for example, vehicles owned by municipality, including buses, ambulances, autonomous ego motions, city patrollers and the like.

Each of the identified subset of vehicles may communicate to one another using a P2P (peer-to-peer), or V2V, or other communication protocol. The identified subset of vehicles may move as a convoy or a platoon, according to a navigation strategy, to collect data of the road and data of the subset of vehicles.

Each of the subset of vehicles may have its own data. The data of each of the subset of vehicles may include a direction, speed, driving pattern, location, road condition, map, location, traffic, object, and environmental condition that the respective one of the subset of vehicles encountered during its travel on the road. The lane identification system 600 may further receive the driving data of the subset of vehicles.

As previously discussed in FIG. 5, data of the road 620 may be collected by one or more sensors of vehicles, including vehicle 610 and the subset of vehicles, and by one or more sensors on the road 620. The lane identification system 600 may analyze such collected data to detect and identify one or more attributes and characteristics of the road 620. Different attributes and characteristics of the road 620 may represent various road conditions. The road condition of a road may include formation on the condition of the road, damages to the road, hazardous features on the road, and attributes of the road (i.e., the color, size, number of lanes, lane markers, shape, etc.). Many variations are possible.

The lane identification system 600 may use the data of the road 620 collected, by one or more sensors of one or more vehicles, such as vehicle 610 and the subset of vehicles, and by one or more sensors on the road 620, to determine one or more attributes and characteristics of the road 620 to detect objects, and other features on the road 620. Different attributes and characteristics of the road may represent various objects, and other features. The lane identification system 600 may determine, from analyzing collected data of the road 620, an object 630, a road feature 632, and an object 634. An object, such as objects 630 and 634, may include, for example, a pothole, crack, tire marking, faded road marking, debris, occlusion, road reflection, flooding, icy surface, fire, oil leak, uneven pavement, erosion, raveling, street signs, traffic lights, light poles, pedestrians, vehicles, bicycles, and buildings. A road feature, such as feature 632, may include, for example, flow of traffic, driving pattern, lane crossing, merging lane markers, slope on the road, and accident.

The lane identification system 600 may determine, from the collected data of road 620, that object 630 may be a pothole, road feature 632 may be an accident, and object 634 may be a speed limit sign. The objects, road features, and the associated attributes and characteristics of a road, such as road 620 may be preset and stored in a database. The objects, road features, and the associated attributes and characteristics of a road, such as road 620, may be updated according to algorithms and models using road conditions data received from various vehicles and various road sensors. Many variations are possible.

The driving data of the subset of vehicles may be analyzed to determine information associated with the lanes of the road 620. Such information associated with the lanes of the road 620, such as lanes 622, 624, 626, and 628, may be considered as lane identification information. The lane identification information of the road may include a lane marker type (i.e., dashed, solid, white, yellow, double, etc.), flow of traffic, driving pattern, obstruction, object, and road condition of each lane 622, 624, 626, and 628 on the road 620.

The lane identification information of the road 620 may be analyzed to determine lane-level patterns, such as driving patterns, for each lane 622, 624, 626, and 628 on the road 620. A lane-level pattern for a lane on a road may be influenced by other lane identification information, such as the flow of traffic, obstructions, objects, and road conditions on the lane. For example, lane identification information may be analyzed to determine that a lane-level pattern for lane 622 on road 620 may have a slower than normal flow of traffic on the road 620, where the normal flow of traffic may be the speed limit of road 620, such as, for example, 65 miles per hour. The slower than normal flow of traffic on lane 622 may be determined to be caused by a pothole, shown as obstruction 630. The lane-level pattern of some vehicles driving on lane 622 may show those respective vehicles moving out of lane 622 and into lane 624 on the right side of lane 622, when the those respective vehicles reach at or close to the pothole of obstruction 630. The lane-level pattern of other vehicles driving on lane 622 may show that those respective vehicles slow down when they reach at or close to the pothole of obstruction 630, but continue to drive straight on lane 622 passing over the pothole of obstruction 630. Lane identification information may be analyzed to determine that a lane-level pattern for lane 624 on road 620 may have a faster than normal flow of traffic on the road 620. The lane-level pattern of vehicles driving on lane 624 may show such vehicles driving straight on lane 624 without changing to another lane. Lane identification information may be analyzed to determine that a lane-level pattern for lane 626 on road 620 may have a significantly slower than normal flow of traffic than the other lanes on the road 620. The slower flow of traffic on lane 626 may be determined to be caused by an accident, shown as road feature 632. The lane-level pattern of lane 626 may further show that all vehicles driving on lane 626 may be moving out of lane 626 and into another lane, either one the right side of lane 626, such as lane 628, or on the left side of lane 626, such as lane 624, when the vehicles reach at or close to the accident of road feature 632. Lane identification information may be analyzed to determine that a lane-level pattern lane 628 on road 620 may have a normal flow of traffic and that vehicles on lane 628 lane drive by objects on the right side of lane 628 every few miles. The objects on the right of lane 628 may be determined to be speed limit signs, shown as object 634.

After analyzing the lane identification information to determine lane-level patterns, such as driving patterns, for each lane 622, 624, 626, and 628 on the road 620, the data of each vehicle of the subset of vehicles may be analyzed to determine a lane-level pattern of the respective vehicle. The lane-level pattern of each vehicle of the subset of vehicles may be analyzed against each other to determine which vehicles of the subset of vehicles has similar, if not the same, lane-level patterns. The vehicles of the subset of vehicles with lane-level patterns found to be similar, if not the same, may be clustered together. The vehicles of the subset of vehicles may be clustered into multiple groups of vehicles according to each of the lane-level patterns determined. Each cluster of vehicles may be associated with a particular lane on the road, according to the lane-level pattern for the particular cluster of vehicles. The lane-level pattern of the one or more clusters of vehicles may be analyzed against the lane-level patterns of each lane on the road. When the lane-level pattern of a cluster of vehicles that is found to be similar, if not the same, as the lane-level pattern of a particular lane, the respective cluster of vehicles may be determined to be traveling on the particular lane on the road.

The lane-level patterns and lane identification information of each lane 622, 624, 626, and 628 on the road 620 may be analyzed to identify each lane 622, 624, 626, and 628 on the road 620. For example, the lane identification information of lane 622 on the road 620 may be analyzed to determine that there is a white dashed lane marker on the right side of lane 622 and a yellow solid lane marker on the left side of lane 622. The lane identification information of lane 624 on the road 620 may be analyzed to determine that there are white dashed lane markers on both the right side and left side of lane 624. The lane identification information of lane 626 on the road 620 may be analyzed to determine that there are white dashed lane markers on both the right side and left side of lane 626. The lane identification information of lane 628 on the road 620 may be analyzed to determine that there is a white dashed lane marker on the left side of lane 628 and a yellow solid lane marker on the right side of lane 628.

Analyzing the lane identification information and the lane-level patterns on the road may determine that there is a high probability that: (1) the vehicles traveling on lane 622 on road 620, as referred to above, are in fact traveling on lane #1 on the road 620; (2) the vehicles traveling on lane 624 on road 620, as referred to above, are in fact traveling on lane #2 on the road 620; (3) the vehicles traveling on lane 626 on road 620, as referred to above, are in fact traveling on lane #3 on the road 620; and (4) the vehicles traveling on lane 628 on road 620, as referred to above, are in fact traveling on lane #4 on the road 620, where the numbering of the lanes on the road 620 are counted from left to right when facing in the direction of traffic, as shown by arrow 640.

The lane identification system 600 may further generate lane identification distribution 650 for the lanes on the road 620. The lane identification information of the road 620 and the position of the vehicle 610 on the road 620 may be analyzed to generate lane identification distribution 650, that may include a lane identification probability for each lane, such as score 652, 654, 656, and 658, where the lane identification probability of a particular lane is indicative of a probability that the vehicle 610 is in the particular lane on the road 620. The lane identification probability score 652, 654, 656, and 658 of each lane on the road 620 may be a value between 0 and 1. The total value of the lane identification probability scores 652, 654, 656, and 658 of all of the lanes on the road 620 may equal 1. The lane on the road 620 with the highest value of lane identification probability may be indicative of the lane on the road 620 that the ego vehicle is most likely located in while traveling on the road. The lane identification distribution 650 may include a lane identification probability 652 for lane 622, lane identification probability 654 for lane 624, lane identification probability 656 for lane 626, and lane identification probability 658 for lane 628.

The sensor data and the map data of vehicle 610 may be analyzed to determine the position of vehicle 610 on the road 620 and features of the lane on the road 620 that vehicle 610 is traveling on. Features of a lane on the road 620 that vehicle 610 may determine from its sensor data and map data may include lane marker types (i.e., dashed, solid, white, yellow, double, etc.), objects, obstructions, flow of traffic, etc. that are on or associated with the respective lane on the road 620. According to the lane identification information of each lane, and the sensor data and map data of vehicle 610, the lane identification system 600 may determine a lane identification distribution 650 with a lane identification probability 652 of 10%, lane identification probability 654 of 60%, lane identification probability 652 of 20%, and lane identification probability 652 of 10% for lanes 622, 624, 626, and 628 on the road 620, respectively. This means that according to the lane identification information of each lane on road 620, and the sensor data and map data of vehicle 610, there is 10% probability that vehicle 610 is in lane 622 on the road 620, a 60% probability that vehicle 610 is in lane 624 on the road 620, a 20% probability that vehicle 610 is in lane 626 on the road 620, and a 10% probability that vehicle 610 is in lane 628 on the road 620.

Each lane identification probability 652, 654, 656, and 658 of lane identification distribution 650 for road 620 may be updated as vehicle 610 travels on the road 620. As vehicle 610 travels on the road 620, vehicle 610 may collect new sensor data and new map data that may update the position of vehicle 610 and information of the road 620 at the updated position of vehicle 610. New lane identification information may also be determined from data of the subset of vehicles at the updated position of vehicle 610 on the road 620. The new sensor data, new map data, and new lane identification information may all be analyzed to update each lane identification probability 652, 654, 656, and 658 of lane identification distribution 650 for road 620 at the updated position of vehicle 610 on the road 620. The updated lane identification probabilities 652, 654, 656, and 658 of lane identification distribution 650 may be indicative of a new set of probabilities that vehicle 610 is in a particular lane on the road 620. The lane identification probabilities 652, 654, 656, and 658 of lane identification distribution 650 may further be updated according to algorithms and models using data received from various vehicles that may not be included in the subset of vehicles.

The lane identification system 600 may output a lane identification of vehicle 610. The lane identification of the vehicle 610 may be indicative of the lane on the road 620 that vehicle 610 is currently traveling on. Analyzing the lane identification probabilities 652, 654, 656, and 658 of lane identification distribution 650 of the road 620 according to the current position of vehicle 610 on the road 620 may determine a lane identification for vehicle 610. For example, based on the lane identification probabilities 652, 654, 656, and 658 of each lane on the road 620, as mentioned above, the lane identification of vehicle 610 may be determined as lane 624, which is lane #2 on the road 620. The lane identification probabilities 652, 654, 656, and 658 of lane identification distribution 650 of the road 620, along with the lane identification for vehicle 610, may be outputted to vehicle 610, a vehicle monitoring system, a vehicle navigation system, etc.

Monitoring data of various vehicles traveling on a road may permit up-to-date lane identification information and road conditions, that may be analyzed to efficiently and accurately determine lane identifications of the road. The efficient and accurate determination of line identifications of the road may improve the navigation of vehicles traveling on the road and increase the avoidance of incidents and accidents occurring on the road.

The lane identification system 600 may be implemented as, for example, the computing component 110 of FIG. 1, the computing system 210 of FIG. 2, the lane identification system 300 of FIG. 3, the process 400 of FIG. 4, the lane identification system 500 of FIG. 5, the computing component 700 of FIG. 7, and the computing component 800 of FIG. 8.

FIG. 7 illustrates an example computing component 700 that includes one or more hardware processors 702 and machine-readable storage media 704 storing a set of machine-readable/machine-executable instructions that, when executed, cause the hardware processor(s) 702 to perform an illustrative method of lane identification. It should be appreciated that there can be additional, fewer, or alternative steps performed in similar or alternative orders, or in parallel, within the scope of the various examples discussed herein unless otherwise stated. The computing component 700 may be implemented as the computing component 110 of FIG. 1, the computing system 210 of FIG. 2, the lane identification system 300 of FIG. 3, the process 400 of FIG. 4, the lane identification system 500 of FIG. 5, the lane identification system 600 of FIG. 6, and the computing component 800 of FIG. 8.

At step 706, the hardware processor(s) 702 may execute machine-readable/machine-executable instructions stored in the machine-readable storage media 704 to identify a plurality of lane-level patterns for a plurality of other vehicles. An ego vehicle may be traveling on a road. The ego vehicle may collect sensor data of the road upon which the ego vehicle is traveling. The ego vehicle may include, for example, an automobile, truck, motorcycle, bicycle, scooter, moped, recreational vehicle and other like on- or off-road vehicles. The ego vehicle may include, for example, an autonomous, semi-autonomous and manual operation.

The ego vehicle may include one or more sensors that may be used to collect sensor data and map data of the road. The sensors may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS). Data may be received from at least one sensor of the ego vehicle. The sensor data may include information on the condition of the road, damages to the road, hazardous features on the road, attributes of the road (i.e., the color, size, type and shape of lane markers, number of lanes, etc.), environmental conditions, lane markers and markings within the lane, map, location, traffic, speed, direction, and objects on, proximate to, and associated with the road that is collected by the ego vehicle. An object on the road may include a pothole, crack, tire marking, faded road marking, debris, occlusion, road reflection, flooding, ice, fire, oil leak, uneven pavement, erosion, raveling, sign, pole, building, structure, pedestrian, animal, and vehicle. The environmental condition may include location, coordinates, population, landscape, landmark, terrain, territory, weather, temperature, humidity, pollution, habitat, and other environmental surroundings on, proximate to, or associated with the road that the ego vehicle is traveling on.

The ego vehicle may collect map data of the road that the ego vehicle is traveling on. The map data, which may be stored onboard the vehicle or obtained from the cloud or other infrastructure element, may include location, coordinates, population, landscape, landmark, terrain, territory, weather, temperature, humidity, pollution, habitat, and other environmental surroundings on, proximate to, and associated with the road that the ego vehicle is traveling on. The map data, sensor data or both may be analyzed to determine a position of the ego vehicle on the road.

One or more vehicles that traversed or that are traversing a determined segment of the road on which the ego vehicle is traveling may be identified. The identification can be based on factors such as the timeframe that the other vehicles traversed the road segment. For example, the identification may be limited to vehicles that traveled on the same road segment within a given amount of time prior to the current time at which the ego vehicle is traveling on the road segment. This time window may be set as a predetermined amount of time and the predetermined amount of time may vary based on the circumstances or conditions.

The identification of vehicles may also be based on a distance threshold to a position of interest of the ego vehicle. This may be determined, for example, based on the road segment (e.g., any vehicle within the identified road segment, or vehicles within the road segment that are also within a determined distance of a position of the ego vehicle) include one or more vehicles within a distance threshold to the position of the ego vehicle. The distance threshold may be a preset value. The distance threshold may vary according to the location of the ego vehicle as determined from the map data. The distance threshold may vary according to conditions and features of the road as determined from the sensor data. The distance threshold may be updated according to algorithms and models using driving data of vehicles. Many variations are possible.

The identified vehicles, hereinafter referred to as the subset of vehicles, may also include one or more vehicles enroute in the same direction on the road as the ego vehicle and that was previously at or near the location of the ego vehicle within a time threshold. A vehicle may be determined to be enroute in the same direction on the road as the ego vehicle according to the vehicle's location and direction of movement. A vehicle may be determined to be enroute in the same direction on the road as the ego vehicle according to a GPS of the vehicle. The GPS of the vehicle may include instructions and directions of a route that the vehicle may follow to reach a particular destination. The instructions and directions of the route of the GPS may include the location of the vehicle. The location of the vehicle may be used to determine an amount of time that has passed since the vehicle was at or near the present location of the ego vehicle. The time threshold may be a preset value. The time threshold may vary according to the location of the ego vehicle as determined from the map data. The time threshold may vary according to conditions and features of the road as determined from the sensor data. The time threshold may be updated according to algorithms and models using driving data of vehicles. Many variations are possible.

The subset of vehicles may further include one or more vehicles that have one or more sensors capable of collecting data of the road and the driving performance of the respective vehicle. One or more sensors, either individually or in combination, may be able to collect data on the road, such as sensor data, to determine conditions and features of the road. The one or more sensors, either individually or in combination, may be able to collect data on the driving performance of the respective vehicle to determine the driving pattern of the respective vehicle on the road. The one or more sensors of the vehicle used to collect data may include, for example, a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

The subset of vehicles may further include one or more vehicles based on performance data of the respective vehicle with regards to how accurately the respective vehicle follows navigation directions, avoids obstructions, and performs defensive driving. The subset of vehicles may further include one or more vehicles that are associated with a lane identification system, such as, for example, vehicles owned by municipality, autonomous ego motions, city patrollers and the like.

Each of the selected subset of vehicles may communicate to one another using a P2P (peer-to-peer), V2V or other communication protocol. The selected subset of vehicles may move as a convoy or a platoon, according to a navigation strategy, to collect driving data of the road.

Each of the subset of vehicles may have its own sensor data. The sensor data of each of the subset of vehicles may include a direction, speed, driving pattern, location, road condition, map, location, traffic, object, and environmental condition that the respective one of the subset of vehicles encountered during its travel on the road.

The sensor data of the subset of vehicles may be analyzed to determine lane-level patterns of the road. The lane-level patterns may include information of a pattern that is performed and/or experienced by vehicles on the road, such as, for example, a driving pattern, acceleration profile pattern, suspension pattern, speed pattern, detected object pattern, road condition pattern, traffic pattern, and direction pattern pertaining to each of the subset of vehicles as they each travel on the road.

At step 710, the hardware processor(s) 702 may execute machine-readable/machine-executable instructions stored in the machine-readable storage media 704 to assign each vehicle of the plurality of other vehicles to one of the lane-level patterns to sort the vehicles of the plurality of other vehicles into one or more cluster of vehicles. Each vehicle of the plurality of other vehicles may have one lane-level pattern that is associated with a pattern that is performed and/or experienced by the respective vehicle while traveling on the road. The lane-level patterns of vehicles on the road may be used to sort each of the subset of vehicles into clusters of vehicles so that each vehicle in a cluster may have a similar, if not the same, lane-level pattern to other vehicles in the same cluster.

At step 712, the hardware processor(s) 702 may execute machine-readable/machine-executable instructions stored in the machine-readable storage media 704 to determine a lane identification for each cluster of vehicles. The sensor data of the vehicles on the road, including the ego vehicle and the subset of vehicles, and the lane-level pattern for each cluster of vehicles, may be analyzed to determine information associated with the lanes of the road. Such information associated with the lanes of the road may be considered as lane identification information. The lane identification information of the road may include a lane marker types (i.e., dashed, solid, white, yellow, double, etc.), flow of traffic, driving pattern, obstruction, object, and road condition of each lane on the road. The lane identification information may be analyzed to identify a lane on the road for each cluster of vehicles. The lane identification information may be analyzed to identify each lane on the road.

At step 714, the hardware processor(s) 702 may execute machine-readable/machine-executable instructions stored in the machine-readable storage media 704 to generate a lane identification distribution for a first vehicle. The lane identification information for each cluster of vehicles on the road and the sensor data of the ego vehicle on the road may be analyzed to generate a lane identification distribution indicative of a set of probabilities that the ego vehicle is traveling in each lane on the road. The lane identification distribution may include a lane identification probability for each lane on the road, and each lane identification probability may be a value between 0 and 1. The total value of the lane identification probabilities of all of the lanes on the road may equal 1. The lane on the road with the highest value of lane identification probability may be indicative of the lane on the road that the ego vehicle is most likely located in while traveling on the road. The lane identification distribution may include each lane identification probability of each lane of the number of lanes on the road.

The lane identification distribution with each lane identification probability of each lane on the road may be updated as the ego vehicle travels on the road. As the ego vehicle travels on the road, the ego vehicle may collect new sensor data and new map data that may update the position of the ego vehicle and information of the road at the updated position of the ego vehicle. New lane identification information may also be determined from driving data of the subset of vehicles at the updated position of the ego vehicle on the road. The new sensor data, new map data, and new lane identification information may all be analyzed to update the lane identification distribution and each lane identification probability of each lane on the road at the updated position of the ego vehicle on the road. The updated lane identification distribution may be indicative of a new set of probabilities that the ego vehicle is traveling in each of the number of lanes on the road. The lane identification distribution may further be updated according to algorithms and models using driving data received from various vehicles that may not be included in the subset of vehicles.

At step 716, the hardware processor(s) 702 may execute machine-readable/machine-executable instructions stored in the machine-readable storage media 704 to estimate a second lane identification for the first vehicle. Analyzing the lane identification probability of each lane on the road according to the current position of the ego vehicle on the road, a lane identification may be determined for the ego vehicle. The lane identification may be indicative of the lane on the road that the ego vehicle is currently traveling on. The lane identification distribution with each of the lane identification probabilities for each lane on the road, along with the lane identification for the ego vehicle, may be outputted to the ego vehicle, a vehicle monitoring system, a vehicle navigation system, etc.

Monitoring data of various vehicles traveling on a road may permit up-to-date lane identification information and road conditions, that may be analyzed to efficiently and accurately determine lane identifications of the road. The efficient and accurate determination of line identifications of the road may improve the navigation of vehicles traveling on the road and increase the avoidance of incidents and accidents occurring on the road.

As used herein, the terms circuit, system, and component might describe a given unit of functionality that can be performed in accordance with one or more applications of the present application. As used herein, a component might be implemented utilizing any form of hardware, software, or a combination thereof. For example, one or more processors, controllers, ASICS, PLAS, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software (such as user device applications described herein), these software elements can be implemented to operate with a computing or processing component capable of carrying out the functionality described with respect thereto. One such example computing component is shown in FIG. 9. Various applications are described in terms of this example-computing component 900. After reading this description, it will become apparent to a person skilled in the relevant art how to implement the application using other computing components or architectures.

Referring now to FIG. 8, computing component 800 may represent, for example, computing or processing capabilities found within a vehicle (e.g., vehicle 150, vehicle 200), user device, self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 800 might also represent computing capabilities embedded within or otherwise available to a given device. For example, a computing component might be found in other electronic devices such as, for example, portable computing devices, and other electronic devices that might include some form of processing capability. In another example, a computing component might be found in components making up vehicle 150, vehicle 200, lane identification circuit 310, decision and control circuit 303, computing system 100, computing system 210, ECU 225, etc.

Computing component 800 might include, for example, one or more processors, controllers, control components, or other processing devices. This can include a processor, and any one or more of the components making up vehicle 150 of FIG. 1, vehicle 200 of FIG. 2, computing system 210 of FIG. 2, lane identification system 300 of FIG. 3, lane identification system 500 of FIG. 5, and lane identification system 600 of FIG. 6. Processor 804 might be implemented using a general-purpose or special-purpose processing engine such as, for example, a microprocessor, controller, or other control logic. The processor 804 might be specifically configured to execute one or more instructions for execution of logic of one or more circuits described herein, such as lane identification circuit 310, decision and control circuit 303, and logic for control systems 240. Processor 804 may be configured to execute one or more instructions for performing one or more methods, such as the process described in FIG. 4 and the method described in FIG. 7.

Processor 804 may be connected to a bus 802. However, any communication medium can be used to facilitate interaction with other components of computing component 800 or to communicate externally. In applications, processor 804 may fetch, decode, and execute one or more instructions to control processes and operations for enabling vehicle servicing as described herein. For example, instructions can correspond to steps for performing one or more steps of the process described in FIG. 4 and the method described in FIG. 7.

Computing component 800 might also include one or more memory components, simply referred to herein as main memory 808. For example, random access memory (RAM) or other dynamic memory, might be used for storing information and instructions to be fetched, decoded, and executed by processor 804. Such instructions may include one or more instructions for execution of one or more logical circuits described herein. Instructions can include instructions 208 of FIG. 2, and instructions 309 of FIG. 3 as described herein, for example. Main memory 808 might also be used for storing temporary variables or other intermediate information during execution of instructions to be fetched, decoded, and executed by processor 804. Computing component 800 might likewise include a read only memory (“ROM”) or other static storage device coupled to bus 802 for storing static information and instructions for processor 804.

The computing component 800 might also include one or more various forms of information storage mechanism 810, which might include, for example, a media drive 812 and a storage unit interface 820. The media drive 812 might include a drive or other mechanism to support fixed or removable storage media 814. For example, a hard disk drive, a solid-state drive, a magnetic tape drive, an optical drive, a compact disc (CD) or digital video disc (DVD) drive (R or RW), or other removable or fixed media drive might be provided. Storage media 814 might include, for example, a hard disk, an integrated circuit assembly, magnetic tape, cartridge, optical disk, a CD or DVD. Storage media 814 may be any other fixed or removable medium that is read by, written to or accessed by media drive 812. As these examples illustrate, the storage media 814 can include a computer usable storage medium having stored therein computer software or data.

In alternative applications, information storage mechanism 810 might include other similar instrumentalities for allowing computer programs or other instructions or data to be loaded into computing component 800. Such instrumentalities might include, for example, a fixed or removable storage unit 822 and an interface 820. Examples of such storage unit 822 and interface 820 can include a program cartridge and cartridge interface, a removable memory (for example, a flash memory or other removable memory component) and memory slot. Other examples may include a PCMCIA slot and card, and other fixed or removable storage units 822 and interfaces 820 that allow software and data to be transferred from storage unit 822 to computing component 800.

Computing component 800 might also include a communications interface 824. Communications interface 824 might be used to allow software and data to be transferred between computing component 800 and external devices. Examples of communications interface 824 might include a modem or softmodem, a network interface (such as Ethernet, network interface card, IEEE 802.XX or other interface). Other examples include a communication port (such as for example, a USB port, IR port, RS232 port Bluetooth® interface, or other port), or other communications interface. Software/data transferred via communications interface 824 may be carried on signals, which can be electronic, electromagnetic (which includes optical) or other signals capable of being exchanged by a given communications interface 824. These signals might be provided to communications interface 824 via a channel 828. Channel 828 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 808, storage unit 822, media 814, and channel 828. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 800 to perform features or functions of the present application as discussed herein.

As described herein, vehicles can be flying, partially submersible, submersible, boats, roadway, off-road, passenger, truck, trolley, train, drones, motorcycle, bicycle, or other vehicles. As used herein, vehicles can be any form of powered or unpowered transport. Obstructions can include one or more potholes, cracks, tire markings, faded road markings, debris, objects, occlusion, road reflection, floodings, icy surfaces, oil leaks, uneven pavement, erosions, raveling and other potentially hazardous conditions on the road. Although roads are references herein, it is understood that the present disclosure is not limited to roads or to 1d or 2d traffic patterns.

The term “operably connected,” “coupled”, or “coupled to”, as used throughout this description, can include direct or indirect connections, including connections without direct physical contact, electrical connections, optical connections, and so on.

The terms “a” and “an,” as used herein, are defined as one or more than one. The term “plurality,” as used herein, is defined as two or more than two. The term “another,” as used herein, is defined as at least a second or more. The terms “including” and “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, or C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof. While various applications of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various applications be implemented to perform the recited functionality in the same order, and with each of the steps shown, unless the context dictates otherwise.

Although the disclosed technology is described above in terms of various exemplary applications and implementations, it should be understood that the various features, aspects and functionality described in one or more of the individual applications are not limited in their applicability to the particular application with which they are described, but instead can be applied, alone or in various combinations, to one or more of the other applications of the disclosed technology, whether or not such applications are described and whether or not such features are presented as being a part of a described application. Thus, the breadth and scope of the technology disclosed herein should not be limited by any of the above-described exemplary applications.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various applications set forth herein are described in terms of exemplary block diagrams, flow charts and other illustrations. As will become apparent to one of ordinary skill in the art after reading this document, the illustrated applications and their various alternatives can be implemented without confinement to the illustrated examples. For example, block diagrams and their accompanying description should not be construed as mandating a particular architecture or configuration.

What is claimed is:

1. A computer implemented method for lane identification of a first vehicle on a road segment, the method comprising:
identifying, based on sensor data from a plurality of other vehicles that traveled on the road segment, a plurality of lane-level patterns for the plurality of other vehicles;
assigning each vehicle of the plurality of other vehicles to one of the lane-level patterns to sort the vehicles of the plurality of other vehicles into one or more clusters of vehicles;
determining a lane identification for each cluster of vehicles;
generating a lane identification distribution for the first vehicle based on sensor data of the first vehicle and the lane identification for each cluster of vehicles; and
estimating a lane identification for the first vehicle based on the generated lane identification distribution.

2. The method of claim 1, wherein the sensor data of a vehicle is obtained from a sensor of the vehicle, the sensor comprising at least one of a camera, image sensor, radar sensor, light detection and ranging (LIDAR) sensor, position sensor, audio sensor, infrared sensor, microwave sensor, optical sensor, haptic sensor, magnetometer, communication system and global positioning system (GPS).

3. The method of claim 1, wherein the sensor data of a vehicle comprises information of an environmental condition, road condition, map, location, lane marker type, traffic, speed, direction, and object encountered by the vehicle.

4. The method of claim 3, wherein the object comprises at least one of a pothole, crack, tire marking, faded road marking, debris, occlusion, road reflection, flooding, ice, fire, oil leak, uneven pavement, erosion, raveling, sign, pole, building, structure, pedestrian, animal, and vehicle.

5. The method of claim 1, wherein the lane-level pattern of a vehicle comprises at least one of an acceleration profile pattern, suspension pattern, speed pattern, detected object pattern, road condition pattern, traffic pattern, direction pattern, and driving pattern.

6. The method of claim 1, wherein the plurality of other vehicles are sorted into clusters of vehicles so that each vehicle in a cluster has a similar lane-level pattern to other vehicles in the cluster.

7. The method of claim 1, further comprising updating the lane identification distribution as the first vehicle traverses the road segment according to the sensor data of the first vehicle and the lane identifications for the one or more clusters of vehicles.

8. The method of claim 1, further comprising outputting the lane identification distribution and the estimated lane identification of the first vehicle.

9. A computing system for lane identification for a first vehicle on a road segment comprising:
one or more processors; and
memory coupled to the one or more processors to store instructions, which when executed by the one or more processors, cause the one or more processors to perform operations, the operations comprising:
identifying, based on sensor data from a plurality of other vehicles that traveled on the road segment, a plurality of lane-level patterns for the plurality of other vehicles;
assigning each vehicle of the plurality of other vehicles to one of the lane-level patterns to sort the vehicles of the plurality of other vehicles into one or more clusters of vehicles;
determining a lane identification for each cluster of vehicles;
generating a lane identification distribution for the first vehicle based on sensor data of the first vehicle and the lane identification for each cluster of vehicles; and
estimating a lane identification for the first vehicle based on the generated lane identification distribution.

10. The computing system of claim 9, wherein the sensor data of a vehicle is obtained from a sensor of the vehicle, the sensor comprising at least one of a camera, image sensor, radar sensor, light detection and ranging (LiDAR) sensor, position sensor, audio sensor, infrared sensor, microwave sensor, optical sensor, haptic sensor, magnetometer, communication system and global positioning system (GPS).

11. The computing system of claim 9, wherein the sensor data of a vehicle comprises information of an environmental condition, map, location, road condition, lane marker type, traffic, speed, direction, and object encountered by the vehicle.

12. The computing system of claim 11, wherein the object comprises at least one of a pothole, crack, tire marking, faded road marking, debris, occlusion, road reflection, flooding, ice, fire, oil leak, uneven pavement, erosion, raveling, sign, pole, building, structure, pedestrian, animal, and vehicle.

13. The computing system of claim 9, wherein the lane-level pattern of a vehicle comprises at least one of an acceleration profile pattern, suspension pattern, speed pattern, detected object pattern, road condition pattern, traffic pattern, direction pattern, and driving pattern.

14. The computing system of claim 9, wherein the plurality of other vehicles are sorted into clusters of vehicles so that each vehicle in a cluster has a similar lane-level pattern to other vehicles in the cluster.

15. The computing system of claim 9, the operations further comprising updating the lane identification distribution as the first vehicle traverses the road segment according to the sensor data of the first vehicle and the lane identifications for the one or more clusters of vehicles.

16. The computing system of claim 9, the operations further comprising outputting the lane identification distribution and the estimated lane identification of the first vehicle.

17. A non-transitory machine-readable medium having instructions stored therein, which when executed by a processor, cause the processor to perform operations, the operations comprising:
identifying, based on sensor data from a plurality of other vehicles that traveled on a road segment, a plurality of lane-level patterns for the plurality of other vehicles;
assigning each vehicle of the plurality of other vehicles to one of the lane-level patterns to sort the vehicles of the plurality of other vehicles into one or more clusters of vehicles;
determining a lane identification for each cluster of vehicles;
generating a lane identification distribution for a first vehicle on the road segment based on sensor data of the first vehicle and the lane identification for each cluster of vehicles; and
estimating a lane identification for the first vehicle based on the generated lane identification distribution.

18. The non-transitory machine-readable medium of claim 17, wherein the plurality of other vehicles are sorted into clusters of vehicles so that each vehicle in a cluster has a similar lane-level pattern to other vehicles in the cluster.

19. The non-transitory machine-readable medium of claim 17, wherein the lane-level pattern of a vehicle comprises at least one of an acceleration profile pattern, suspension pattern, speed pattern, detected object pattern, road condition pattern, traffic pattern, direction pattern, and driving pattern.

20. The non-transitory machine-readable medium of claim 17, the operations further comprising outputting the lane identification distribution and the estimated lane identification of the first vehicle.
